(19) United States
(12) Patent Application Publication
(10) Pub. No.: US 2007/0165649 A1
(43) Pub. Date: Jul. 19, 2007

(54) Behavior Management Systems

(76) Inventor: John F. Moritz, Tucson, AZ (US)

Correspondence Address: STONEMAN LAW OFFICES, LTD, 3113 NORTH 3RD STREET, PHOENIX, AZ, 85012, US

(21) Appl. No.: 11/617,548

(22) Filed: Dec. 28, 2006

Related U.S. Application Data
(60) Provisional application No. 60/755,317, filed on Dec. 30, 2005.

(51) Int. Cl. H04L 12/56

(52) U.S. Cl. 370/395.64

(57) ABSTRACT

A behavior modification system, for school and institutional settings, comprising Internet-enabled software adapted to receive reports of misbehavior and to automatically generate, schedule, and track consequences for the misbehavior. The system also has the capability to receive reports of serious misbehavior and automatically transmit those reports to school administrators, parents, etc. The system assists teachers and administrators to provide simple, consistent, and objective negative feedback for improper student behavior.

### CROSS-REFERENCE TO RELATED APPLICATION

The present application is related to and claims priority from prior provisional application Ser. No. 60/755,317, filed Dec. 30, 2005, entitled “BEHAVIOR MANAGEMENT SYSTEMS”, the contents of which are incorporated herein by this reference and are not admitted to be prior art with respect to the present invention by the mention in this cross-reference section.

### BACKGROUND

The present invention relates to behavior management systems. More particularly, the present invention relates to computerized behavior management systems adapted to track behavior infractions. Even more particularly, the present invention relates to computerized behavior management systems adapted to track behavior infractions and to automatically assign consequences based on a subject's past and current behavior infractions.

No system exists that tracks subject's behavior and automatically assigns consequences for the subject's behavior. Further, no system exists that automatically e-mails behavior notices to a subject's authority figures. Even further, no system exists to provide a centralized website for tracking behavior data, where multiple groups each have customized website interfaces to their own customized databases.

Therefore, a need exists for a system that tracks subject's behavior and automatically assigns consequences for the subject's behavior. Further, a need exists for a system that automatically e-mails behavior notices to a subject's authority figures. Even further, a need exists for a system adapted to provide a centralized website for tracking behavior data, where multiple groups each have customized website interfaces to their own customized databases.

### OBJECTS AND FEATURES OF THE INVENTION

A primary object and feature of the present invention is to provide systems for behavior management. It is a further primary object and feature of the present invention to provide behavior modification methods utilizing a computerized, internet-accessible database of subject behavior infractions. It is a further primary object and feature of the present invention to provide behavior modification computer systems adapted to automatically calculate consequences based on infraction data for a particular subject. It is a further primary object and feature of the present invention to provide behavior modification computer systems adapted to store and calculate infraction data for multiple independent groups of subjects.

It is a further object and feature of the present invention to provide such a system adapted to automatically e-mail interested parties when new infraction data for a particular subject is entered into the behavior database. It is a further object and feature of the present invention to provide such a system adapted to automatically assign additional consequences to a subject if a prior consequence is not completed by the subject. It is a further object and feature of the present invention to provide such a system adapted to automatically increase a subject's consequence level after a certain number of behavior infractions.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a computer-assisted discipline tracking method, relating to tracking at least one discipline incident relating to at least one subject of at least one subject group using automatic imposition of multiple preset incident consequences, comprising the steps of: providing at least one Internet web site having at least one discipline database containing at least one nth discipline incident data related to such at least one subject; automatically associating such at least one nth discipline incident data with at least one nth consequence level; automatically associating such at least one nth consequence level with at least one nth consequence fulfillment exercise; receiving at least one (n+1)th discipline incident data relating to such at least one subject into such at least one discipline database; automatically increasing from such at least one nth consequence level to at least one (n+1)th consequence level; automatically associating at least one (n+1)th consequence fulfillment exercise with such at least one (n+1)th consequence level; automatically assigning such at least one (n+1)th consequence fulfillment exercise to such at least one subject; and automatically receiving assignment data relating to such at least one (n+1)th consequence fulfillment exercise into such at least one discipline database.

Moreover, it provides such a computer-assisted discipline tracking method, further comprising the step of communicating such at least one (n+1)th consequence level to such at least one subject. Additionally, it provides such a computer-assisted discipline tracking method, further comprising the steps of generating at least one schedule relating to performing such at least one (n+1)th consequence fulfillment exercise and receiving such at least one schedule into such at least one discipline database. Also, it provides such a computer-assisted discipline tracking method, further comprising the step of communicating such at least one schedule to such at least one subject. In addition, it provides such a computer-assisted discipline tracking method, further comprising the step of receiving data relating to completion of such at least one (n+1)th consequence fulfillment exercise by such at least one subject into such at least one discipline database. And, it provides such a computer-assisted discipline tracking method, further comprising the steps of: automatically communicating such at least one (n+1)th discipline incident data to at least one authority; and automatically communicating such at least one (n+1)th consequence fulfillment exercise schedule to such at least one authority.

Further, it provides such a computer-assisted discipline tracking method, further comprising the step of automatically communicating such at least one (n+1)th consequence level to such at least one authority. Even further, it provides such a computer-assisted discipline tracking method, further comprising the step of automatically communicating such at least one (n+1)th consequence fulfillment exercise to such at least one authority. Moreover, it provides such a computer-assisted discipline tracking method, wherein such at least one authority comprises at least one parent. Additionally, it provides such a computer-assisted discipline tracking method, wherein such at least one authority comprises at least one school official. Also, it provides such a computer-assisted discipline tracking method, further comprising the steps of: automatically communicating such at least one (n+1)th discipline incident data to at least one remote authority; automatically communicating such at least one (n+1)th consequence fulfillment exercise schedule to such at least one remote authority. In addition, it provides such a computer-assisted discipline tracking method, further comprising the step of automatically communicating such at least one (n+1)th consequence level to such at least one remote authority.

And, it provides such a computer-assisted discipline tracking method, further comprising the step of automatically communicating such at least one (n+1)th consequence fulfillment exercise to such at least one remote authority. Further, it provides such a computer-assisted discipline tracking method, wherein such at least one remote authority comprises at least one parent. Even further, it provides such a computer-assisted discipline tracking method, wherein such at least one remote authority comprises at least one school official. Moreover, it provides such a computer-assisted discipline tracking method, further comprising the step of programming at least one association between such at least one nth consequence level and such at least one nth consequence fulfillment exercise. Additionally, it provides such a computer-assisted discipline tracking method, wherein such at least one subject comprises at least one student.

In accordance with another preferred embodiment hereof, this invention provides a computer-assisted discipline tracking method, relating to tracking at least one discipline incident relating to at least one subject of at least one subject group using automatic imposition of multiple preset incident consequences, comprising the steps of: providing at least one Internet web site, having at least one discipline database containing at least one nth discipline incident data related to such at least one subject, and adapted to perform the steps of automatically associating such at least one nth discipline incident data with at least one nth consequence level; automatically associating such at least one nth consequence level with at least one nth consequence fulfillment exercise; receiving at least one (n+1)th discipline incident data relating to such at least one subject into such at least one discipline database; automatically increasing from such at least one nth consequence level to at least one (n+1)th consequence level; automatically associating at least one (n+1)th consequence fulfillment exercise with such at least one (n+1)th consequence level; automatically assigning such at least one (n+1)th consequence fulfillment exercise to such at least one subject; and automatically receiving assignment data relating to such at least one (n+1)th consequence fulfillment exercise into such at least one discipline database; and receiving at least one fee for access to such at least one Internet web site.

Also, it provides such a computer-assisted discipline tracking method, further comprising the step of customizing such at least one discipline database to accommodate user-defined discipline incident data. In addition, it provides such a computer-assisted discipline tracking method, further comprising the step of customizing such at least one Internet web site to provide at least one user-defined interface to such at least one discipline database. And, it provides such a computer-assisted discipline tracking method, further comprising the step of providing at least one distinct instance of such at least one discipline database to each of at least two distinct subject groups through such at least one Internet web site. Further, it provides such a computer-assisted discipline tracking method, further comprising the step of providing at least one subject group Internet web site to each of at least two distinct subject groups within such at least one Internet web site.

Even further, it provides such a computer-assisted discipline tracking method, further comprising the step of providing at least one subject group Internet web site and at least one subject group discipline database to each of at least two distinct subject groups through such at least one Internet web site. Moreover, it provides such a computer-assisted discipline tracking method, further comprising the step of providing data security for such at least one subject group Internet web site and such at least one subject group discipline database. Additionally, it provides such a computer-assisted discipline tracking method, further comprising the step of updating the programming of such at least one subject group Internet web site. Also, it provides such a computer-assisted discipline tracking method, further comprising the step of updating the programming of such at least one subject group discipline database. In addition, it provides such a computer-assisted discipline tracking method, further comprising the step of performing at least one statistical analysis on data contained in at least two subject group discipline databases. And, it provides such a computer-assisted discipline tracking method, further comprising the step of selling anonymous copies of data contained in at least two subject group discipline databases. Further, it provides such a computer-assisted discipline tracking method, further comprising the step of providing backups of data contained in at least two subject group discipline databases.

In accordance with another preferred embodiment hereof, this invention provides a behavior modification method, relating to computerized tracking of behavior data, comprising the steps of: storing past behavior data in at least one computer database; receiving current behavior data into such at least one computer database; computerized calculation of at least one response level based on such past behavior data and such current behavior data; computerized calculation of at least one reinforcement exercise based on such at least one response level; computerized scheduling of such at least one reinforcement exercise; computerized reporting of such at least one reinforcement exercise; storing at least one record of such at least one reinforcement exercise into such at least one computer database; receiving tracking data relating to the completion of such at least one reinforcement exercise into such at least one computer database; wherein such step of computerized calculation of at least one response level comprises the step of automatically incrementing such at least one response level upon each incidence of such step of receiving current behavior data.

In accordance with another preferred embodiment hereof, this invention provides a behavior tracking method, relating to computerized storage and manipulation of behavior data, comprising the steps of: providing at least one Internet data server comprising at least one nth subdirectory comprising at least one nth student discipline database; at least one nth customized database interface; and at least one (n+1)th subdirectory comprising at least one (n+1)th student discipline database; at least one (n+1)th customized database interface; permitting at least one authorized user of such at least one nth student discipline database to alter only data contained in such at least one nth student discipline database, using such at least one nth customized database interface; and permitting at least one authorized user of such at least one (n+1)th student discipline database to alter only data contained in such at least one (n+1)th student discipline database, using such at least one (n+1)th customized database interface.

In accordance with another preferred embodiment hereof, this invention provides a computer-assisted discipline tracker, relating to tracking behavior information relating to at least one subject of at least one subject group using automatic imposition of incremented preset consequences, comprising: at least one nth discipline incident data adapted to document at least one nth behavior information related to such at least one subject; at least one (n+1)th discipline incident data adapted to document at least one (n+1)th behavior information related to such at least one subject; at least one computer data storage adapted to contain such at least one nth incident data and such at least one (n+1)th discipline incident data; at least one Internet computer processor adapted to provide Internet access to such at least one computer data storage; at least one nth consequence level data adapted to identify at least one nth consequence level; at least one (n+1)th consequence level data adapted to identify at least one (n+1)th consequence level; at least one nth consequence fulfillment exercise data adapted to identify at least one nth consequence fulfillment exercise; at least one (n+1)th consequence fulfillment exercise data adapted to identify at least one (n+1)th consequence fulfillment exercise; at least one automatic nth level data associator computer processor adapted to automatically associate such at least one nth discipline incident data with such at least one nth consequence level; at least one automatic (n+1)th level data associator computer processor adapted to automatically associate such at least one (n+1)th discipline incident data with such at least one (n+1)th consequence level; at least one automatic nth exercise data associator computer processor adapted to automatically associate such at least one nth consequence level data with such at least one nth consequence fulfillment exercise; at least one automatic (n+1)th exercise data associator computer processor adapted to automatically associate such at least one (n+1)th consequence level data with such at least one (n+1)th consequence fulfillment exercise data; at least one data receiver computer processor adapted to receive such at least one (n+1)th discipline incident data into such at least one computer data storage; at least one automatic (n+1)th level data increaser computer processor adapted to automatically increase from such at least one nth consequence level to such at least one (n+1)th consequence level after such at least one data receiver computer processor receives such at least one (n+1)th discipline incident data into such at least one computer data storage; at least one automatic (n+1)th exercise data assigner computer processor adapted to automatically assign such at least one (n+1)th consequence fulfillment exercise to such at least one subject after such at least one automatic (n+1)th level data increaser computer processor automatically increases from such at least one nth consequence level to such at least one (n+1)th consequence level; and at least one automatic (n+1)th assignment receiver computer processor adapted to automatically receive assignment data relating to such at least one (n+1)th consequence fulfillment exercise into such at least one computer data storage after such at least one automatic (n+1)th exercise data assigner computer processor automatically assigns such at least one (n+1)th consequence fulfillment exercise to such at least one subject.

Even further, it provides such a computer-assisted discipline tracker, further comprising at least one communicator computer processor adapted to communicate such at least one (n+1)th consequence level to such at least one subject. Moreover, it provides such a computer-assisted discipline tracker, further comprising at least one schedule generator computer processor, adapted to generate at least one (n+1)th consequence fulfillment schedule data adapted to schedule performing such at least one (n+1)th consequence fulfillment exercise, and adapted to receive such at least one (n+1)th consequence fulfillment schedule data into such at least one computer data storage. Additionally, it provides such a computer-assisted discipline tracker, further comprising at least one schedule communicator computer processor adapted to communicate such at least one schedule data to such at least one subject.

Also, it provides such a computer-assisted discipline tracker, further comprising at least one exercise data receiver computer processor adapted to receive data relating to completion of such at least one (n+1)th consequence fulfillment exercise by such at least one subject into such at least one computer data storage. In addition, it provides such a computer-assisted discipline tracker, further comprising: at least one automatic authority incident communicator computer processor adapted to automatically communicate such at least one (n+1)th discipline incident data to at least one authority; and at least one automatic authority schedule communicator computer processor adapted to automatically communicate such at least one (n+1)th consequence fulfillment exercise schedule data to such at least one authority. And, it provides such a computer-assisted discipline tracker, further comprising at least one automatic authority level data communicator computer processor adapted to automatically communicate such at least one (n+1)th consequence level data to such at least one authority.

Further, it provides such a computer-assisted discipline tracker, further comprising at least one automatic authority exercise data communicator computer processor adapted to automatically communicate such at least one (n+1)th consequence fulfillment exercise data to such at least one authority. Even further, it provides such a computer-assisted discipline tracker, wherein such at least one authority comprises at least one parent. Moreover, it provides such a computer-assisted discipline tracker, wherein such at least one authority comprises at least one school official. Additionally, it provides such a computer-assisted discipline tracker, further comprising: at least one automatic remote authority incident communicator computer processor adapted to automatically communicate such at least one (n+1)th discipline incident data to at least one remote authority; at least one automatic remote authority schedule communicator computer processor adapted to automatically communicate such at least one (n+1)th consequence fulfillment exercise schedule data to such at least one remote authority.

Also, it provides such a computer-assisted discipline tracker, further comprising at least one automatic remote authority level data communicator computer processor adapted to automatically communicate such at least one (n+1)th consequence level data to such at least one remote authority. In addition, it provides such a computer-assisted discipline tracker, further comprising at least one automatic remote authority exercise data communicator computer processor adapted to automatically communicate such at least one (n+1)th consequence fulfillment exercise data to such at least one remote authority. And, it provides such a computer-assisted discipline tracker, wherein such at least one remote authority comprises at least one parent. Further, it provides such a computer-assisted discipline tracker, wherein such at least one remote authority comprises at least one school official. Even further, it provides such a computer-assisted discipline tracker, wherein such automatic remote authority incident communicator computer processor comprises at least one e-mail computer processor.

Moreover, it provides such a computer-assisted discipline tracker, wherein such automatic remote authority schedule communicator computer processor comprises at least one e-mail computer processor. Additionally, it provides such a computer-assisted discipline tracker, wherein such automatic remote authority level data communicator computer processor comprises at least one e-mail computer processor. Also, it provides such a computer-assisted discipline tracker, wherein such automatic remote authority exercise data communicator computer processor comprises at least one e-mail computer processor. In addition, it provides such a computer-assisted discipline tracker, further comprising at least one nth level data programmer computer processor adapted to program at least one association between such at least one nth consequence level data and such at least one nth consequence fulfillment exercise data.

And, it provides such a computer-assisted discipline tracker, further comprising at least one (n+1)th level data programmer computer processor adapted to program at least one association between such at least one (n+1)th consequence level data and such at least one (n+1)th consequence fulfillment exercise data. Further, it provides such a computer-assisted discipline tracker, wherein such at least one subject comprises at least one student. Even further, it provides such a computer-assisted discipline tracker, wherein such at least one subject comprises at least one child. Moreover, it provides such a computer-assisted discipline tracker, wherein such at least one subject comprises at least one inmate.

In accordance with another preferred embodiment hereof, this invention provides a computer-assisted discipline tracker, relating to tracking behavior information relating to at least one subject of at least one subject group using automatic imposition of incremented preset consequences, comprising: at least one nth discipline incident data adapted to document at least one nth behavior information related to such at least one subject; at least one (n+1)th discipline incident data adapted to document at least one (n+1)th behavior information related to such at least one subject; at least one computer data storage adapted to contain such at least one nth incident data and such at least one (n+1)th discipline incident data; at least one Internet computer processor adapted to provide Internet access to such at least one computer data storage; at least one nth consequence level data adapted to identify at least one nth consequence level; at least one (n+1)th consequence level data adapted to identify at least one (n+1)th consequence level; at least one nth consequence fulfillment exercise data adapted to identify at least one nth consequence fulfillment exercise; at least one (n+1)th consequence fulfillment exercise data adapted to identify at least one (n+1)th consequence fulfillment exercise; at least one automatic nth level data associator computer processor adapted to automatically associate such at least one nth discipline incident data with such at least one nth consequence level data; at least one automatic (n+1) level data associator computer processor adapted to automatically associate such at least one (n+1)th discipline incident data with such at least one (n+1)th consequence level data; at least one automatic nth exercise data associator computer processor adapted to automatically associate such at least one nth consequence level data with such at least one nth consequence fulfillment exercise data; at least one automatic (n+1)th exercise data associator computer processor adapted to automatically associate such at least one (n+1)th consequence level data with such at least one (n+1)th consequence fulfillment exercise data; at least one data receiver computer processor adapted to receive such at least one (n+1)th discipline incident data into such at least one computer data storage; at least one automatic (n+1)th level data increaser computer processor adapted to automatically increase from such at least one nth consequence level to such at least one (n+1)th consequence level after such at least one data receiver computer processor receives such at least one (n+1)th discipline incident data into such at least one computer data storage; at least one automatic (n+1)th exercise data assigner computer processor adapted to automatically assign such at least one (n+1)th consequence fulfillment exercise to such at least one subject after such at least one automatic (n+1)th level data increaser computer processor automatically increases from such at least one nth consequence level to such at least one (n+1)th consequence level; at least one automatic (n+1)th assignment receiver computer processor adapted to automatically receive assignment data relating to such at least one (n+1)th consequence fulfillment exercise into such at least one computer data storage after such at least one automatic (n+1)th exercise data assigner computer processor automatically assigns such at least one (n+1)th consequence fulfillment exercise to such at least one subject; and at least one fee receiver computer processor adapted to receive at least one fee relating to access to such at least one computer data storage.

Additionally, it provides such a computer-assisted discipline tracker, further comprising at least one database customizer computer processor adapted to customize such at least one computer data storage to accommodate user-defined discipline incident data. Also, it provides such a computer-assisted discipline tracker, further comprising at least one web site customizer computer processor adapted to customize such at least one Internet computer processor to provide at least one user-defined interface computer processor to such at least one computer data storage. In addition, it provides such a computer-assisted discipline tracker, further comprising at least one distinct database provider computer processor adapted to provide at least one distinct instance of such at least one computer data storage to each of at least two distinct subject groups through such at least one Internet computer processor. And, it provides such a computer-assisted discipline tracker, further comprising at least one group web site provider computer processor adapted to provide at least one subject group Internet web site to each of at least two distinct subject groups through such at least one Internet computer processor.

Further, it provides such a computer-assisted discipline tracker, further comprising at least one group discipline tracker computer processor adapted to provide at least one subject group Internet web site, and at least one subject group computer data storage, to each of at least two distinct subject groups through such at least one Internet computer processor. Even further, it provides such a computer-assisted discipline tracker, further comprising at least one security provider computer processor adapted to provide data security to such at least one subject group Internet web site and to such at least one subject group computer data storage. Moreover, it provides such a computer-assisted discipline tracker, further comprising at least one web site updater computer processor adapted to update the programming of such at least one subject group Internet web site. Additionally, it provides such a computer-assisted discipline tracker, further comprising at least one database updater computer processor adapted to update the programming of such at least one subject group computer data storage.

Also, it provides such a computer-assisted discipline tracker, further comprising at least one analyzer computer processor adapted to perform at least one statistical analysis on data contained in at least two subject group computer data storages. In addition, it provides such a computer-assisted discipline tracker, further comprising at least one data seller computer processor adapted to sell anonymous copies of data contained in at least two subject group computer data storages. And, it provides such a computer-assisted discipline tracker, further comprising at least one backup provider computer processor adapted to provide at least one backup of data contained in at least two subject group computer data storages.

In accordance with another preferred embodiment hereof, this invention provides a behavior modification system, relating to computerized tracking of behavior data, comprising: at least one computer data storage adapted to provide at least one computerized database; at least one storer computer processor adapted to store past behavior data in such at least one computer data storage; at least one receiver computer processor adapted to receive current behavior data into such at least one computer data storage; at least one computerized level data calculator computer processor adapted to perform computerized calculation of at least one response level based on such past behavior data and such current behavior data; at least one computerized exercise data calculator computer processor adapted to perform computerized calculation of at least one reinforcement exercise based on such at least one response level; at least one computerized scheduler computer processor adapted to perform computerized scheduling of such at least one reinforcement exercise; at least one computerized reporter adapted to perform computerized reporting of such at least one reinforcement exercise; at least one computerized exercise data storer computer processor adapted to store at least one record of such at least one reinforcement exercise into such at least one computer data storage; at least one tracking data receiver computer processor adapted to receive tracking data relating to the completion of such at least one reinforcement exercise into such at least one computer data storage; wherein such at least one computerized level data calculator computer processor automatically increments such at least one response level upon each incidence of such at least one receiver computer processor receiving current behavior data.

In accordance with another preferred embodiment hereof, this invention provides a behavior tracking system, relating to computerized storage and manipulation of behavior data, comprising: at least one Internet server provider computer processor adapted to provide at least one Internet data server comprising at least one nth subdirectory comprising at least one nth computer data storage program; at least one nth custom interface program; and at least one (n+1)th subdirectory comprising at least one (n+1)th computer data storage program; at least one (n+1)th custom interface program; at least one nth authorizer computer processor adapted to only permit at least one authorized user of such at least one nth computer data storage program to alter data contained in such at least one nth student computer data storage program, using such at least one nth custom interface program; and at least one (n+1)th authorizer computer processor adapted to only permit at least one authorized user of such at least one (n+1)th computer data storage program to alter data contained in such at least one (n+1)th student computer data storage program, using such at least one (n+1)th custom interface program.

In accordance with another preferred embodiment hereof, this invention provides a computer-assisted discipline tracking system, relating to tracking behavior information relating to at least one subject of at least one subject group using automatic imposition of incremented preset consequences, comprising: nth discipline incident data means for documenting nth behavior information related to such at least one subject; (n+1)th discipline incident data means for documenting (n+1)th behavior information related to such at least one subject; discipline database means for containing such nth incident data means and such (n+1)th discipline incident data means; Internet provider means for providing Internet access to such discipline database means; nth consequence level means for identifying at least one nth consequence level; (n+1)th consequence level means for identifying at least one (n+1)th consequence level; nth consequence fulfillment exercise means for identifying at least one nth consequence fulfillment exercise; (n+1)th consequence fulfillment exercise means for identifying at least one (n+1)th consequence fulfillment exercise; automatic nth level associator means for automatically associating such nth discipline incident data means with such nth consequence level means; automatic (n+1) level associator means for automatically associating such (n+1)th discipline incident data means with such (n+1)th consequence level means; automatic nth exercise associator means for automatically associating such nth consequence level means with such nth consequence fulfillment exercise means; automatic (n+1)th exercise associator means for automatically associating such (n+1)th consequence level means with such (n+1)th consequence fulfillment exercise means; data receiver means for receiving such (n+1)th discipline incident data means into such discipline database means; automatic (n+1)th level increaser means for automatically increasing from such nth consequence level means to such (n+1)th consequence level means after such data receiver means receives such (n+1)th discipline incident data means into such discipline database means; automatic (n+1)th exercise assigner means for automatically assigning such (n+1)th consequence fulfillment exercise means to such at least one subject after such automatic (n+1)th level increaser means automatically increases from such nth consequence level means to such (n+1)th consequence level means; and automatic (n+1)th assignment receiver means for automatically receiving assignment data relating to such (n+1)th consequence fulfillment exercise means into such discipline database means after such automatic (n+1)th exercise assigner means automatically assigns such (n+1)th consequence fulfillment exercise means to such at least one subject.

Further, it provides such a computer-assisted discipline tracking system, further comprising communicator means for communicating such (n+1)th consequence level means to such at least one subject. Even further, it provides such a computer-assisted discipline tracking system, further comprising schedule generator means, for generating schedule means for scheduling performing such (n+1)th consequence fulfillment exercise means, and for receiving such schedule means into such discipline database means. Moreover, it provides such a computer-assisted discipline tracking system, further comprising schedule communicator means for communicating such schedule means to such at least one subject. Additionally, it provides such a computer-assisted discipline tracking system, further comprising exercise data receiver means for receiving data relating to completion of such (n+1)th consequence fulfillment exercise means by such at least one subject into such discipline database means.

Also, it provides such a computer-assisted discipline tracking system, further comprising: automatic authority incident communication means for automatically communicating such (n+1)th discipline incident data means to at least one authority; and automatic authority schedule communication means for automatically communicating such (n+1)th consequence fulfillment exercise schedule means to such at least one authority. In addition, it provides such a computer-assisted discipline tracking system, further comprising automatic authority level communication means for automatically communicating such (n+1)th consequence level means to such at least one authority. And, it provides such a computer-assisted discipline tracking system, further comprising automatic authority exercise communication means for automatically communicating such (n+1)th consequence fulfillment exercise means to such at least one authority. Further, it provides such a computer-assisted discipline tracking system, wherein such at least one authority comprises at least one parent. Even further, it provides such a computer-assisted discipline tracking system, wherein such at least one authority comprises at least one school official.

Moreover, it provides such a computer-assisted discipline tracking system, further comprising: automatic remote authority incident communication means for automatically communicating such (n+1)th discipline incident data to at least one remote authority; automatic remote authority schedule communication means for automatically communicating such (n+1)th consequence fulfillment exercise schedule to such at least one remote authority. Additionally, it provides such a computer-assisted discipline tracking system, further comprising automatic remote authority level communication means for automatically communicating such (n+1)th consequence level to such at least one remote authority. Also, it provides such a computer-assisted discipline tracking system, further comprising automatic remote authority exercise communication means for automatically communicating such (n+1)th consequence fulfillment exercise to such at least one remote authority. In addition, it provides such a computer-assisted discipline tracking system, wherein such at least one remote authority comprises at least one parent.

And, it provides such a computer-assisted discipline tracking system, wherein such at least one remote authority comprises at least one school official. Further, it provides such a computer-assisted discipline tracking system, wherein such automatic remote authority incident communication means comprises e-mail. Even further, it provides such a computer-assisted discipline tracking system, wherein such automatic remote authority schedule communication means comprises e-mail. Moreover, it provides such a computer-assisted discipline tracking system, wherein such automatic remote authority level communication means comprises e-mail. Additionally, it provides such a computer-assisted discipline tracking system, wherein such automatic remote authority exercise communication means comprises e-mail. Also, it provides such a computer-assisted discipline tracking system, further comprising nth level programmer means for programming at least one association between such nth consequence level means and such nth consequence fulfillment exercise means.

In addition, it provides such a computer-assisted discipline tracking system, further comprising (n+1)th level programmer means for programming at least one association between such (n+1)th consequence level means and such (n+1)th consequence fulfillment exercise means. And, it provides such a computer-assisted discipline tracking system, wherein such at least one subject comprises at least one student. Further, it provides such a computer-assisted discipline tracking system, wherein such at least one subject comprises at least one child. Even further, it provides such a computer-assisted discipline tracking system, wherein such at least one subject comprises at least one inmate.

In accordance with another preferred embodiment hereof, this invention provides a computer-assisted discipline tracking system, relating to tracking behavior information relating to at least one subject of at least one subject group using automatic imposition of incremented preset consequences, comprising: nth discipline incident data means for documenting nth behavior information related to such at least one subject; (n+1)th discipline incident data means for documenting (n+1)th behavior information related to such at least one subject; discipline database means for containing such nth incident data means and such (n+1)th discipline incident data means; Internet provider means for providing Internet access to such discipline database means; nth consequence level means for identifying at least one nth consequence level; (n+1)th consequence level means for identifying at least one (n+1)th consequence level; nth consequence fulfillment exercise means for identifying at least one nth consequence fulfillment exercise; (n+1)th consequence fulfillment exercise means for identifying at least one (n+1)th consequence fulfillment exercise; automatic nth level associator means for automatically associating such nth discipline incident data means with such nth consequence level means; automatic (n+1) level associator means for automatically associating such (n+1)th discipline incident data means with such (n+1)th consequence level means; automatic nth exercise associator means for automatically associating such nth consequence level means with such nth consequence fulfillment exercise means; automatic (n+1)th exercise associator means for automatically associating such (n+1)th consequence level means with such (n+1)th consequence fulfillment exercise means; data receiver means for receiving such (n+1)th discipline incident data means into such discipline database means; automatic (n+1)th level increaser means for automatically increasing from such nth consequence level means to such (n+1)th consequence level means after such data receiver means receives such (n+1)th discipline incident data means into such discipline database means; automatic (n+1)th exercise assigner means for automatically assigning such (n+1)th consequence fulfillment exercise means to such at least one subject after such automatic (n+1)th level increaser means automatically increases from such nth consequence level means to such (n+1)th consequence level means; and automatic (n+1)th assignment receiver means for automatically receiving assignment data relating to such (n+1)th consequence fulfillment exercise means into such discipline database means after such automatic (n+1)th exercise assigner means automatically assigns such (n+1)th consequence fulfillment exercise means to such at least one subject; fee receiver means for receiving at least one fee relating to access to such discipline database means.

Moreover, it provides such a computer-assisted discipline tracking system, further comprising database customizer means for customizing such discipline database means to accommodate user-defined discipline incident data. Additionally, it provides such a computer-assisted discipline tracking system, further comprising web site customizer means for customizing such Internet provider means to provide at least one user-defined interface to such discipline database means. Also, it provides such a computer-assisted discipline tracking system, further comprising distinct database provider means for providing at least one distinct instance of such discipline database means to each of at least two distinct subject groups through such Internet provider means.

In addition, it provides such a computer-assisted discipline tracking system, further comprising group web site provider means for providing at least one subject group Internet web site to each of at least two distinct subject groups through such Internet provider means. And, it provides such a computer-assisted discipline tracking system, further comprising group discipline tracker means for providing at least one subject group Internet web site, and at least one subject group discipline database, to each of at least two distinct subject groups through such Internet provider means. Further, it provides such a computer-assisted discipline tracking system, further comprising security provider means for providing data security to such at least one subject group Internet web site and such at least one subject group discipline database. Even further, it provides such a computer-assisted discipline tracking system, further comprising web site updater means for updating the programming of such at least one subject group Internet web site. Moreover, it provides such a computer-assisted discipline tracking system, further comprising database updater means for updating the programming of such at least one subject group discipline database.

Additionally, it provides such a computer-assisted discipline tracking system, further comprising analyzer means for performing at least one statistical analysis on data contained in at least two subject group discipline databases. Also, it provides such a computer-assisted discipline tracking system, further comprising data seller means for selling anonymous copies of data contained in at least two subject group discipline databases. In addition, it provides such a computer-assisted discipline tracking system, further comprising backup provider means for providing backups of data contained in at least two subject group discipline databases.

In accordance with another preferred embodiment hereof, this invention provides a behavior modification system, relating to computerized tracking of behavior data, comprising: computer database means for providing at least one computerized database; storer means for storing past behavior data in such computer database means; receiver means for receiving current behavior data into such computer database means; computerized level calculator means for computerized calculation of at least one response level based on such past behavior data and such current behavior data; computerized exercise calculator means for computerized calculation of at least one reinforcement exercise based on such at least one response level; computerized scheduler means for computerized scheduling of such at least one reinforcement exercise; computerized reporter means for computerized reporting of such at least one reinforcement exercise; computerized storer means for storing at least one record of such at least one reinforcement exercise into such computer database means; tracking data receiver means for receiving tracking data relating to the completion of such at least one reinforcement exercise into such computer database means; wherein such computerized level calculator means automatically increments such at least one response level upon each incidence of such receiver means receiving current behavior data.

In accordance with another preferred embodiment hereof, this invention provides a behavior tracking system, relating to computerized storage and manipulation of behavior data, comprising: Internet server provider means for providing at least one Internet data server comprising nth subdirectory means for providing at least one nth subdirectory comprising nth database means for providing at least one nth student discipline database; nth interface means for providing at least one nth customized database interface; and (n+1)th subdirectory means for providing at least one (n+1)th subdirectory comprising (n+1)th database means for providing at least one (n+1)th student discipline database; (n+1)th interface means for providing at least one (n+1)th customized database interface; nth authorizer means for permitting at least one authorized user of such nth student discipline database to alter only data contained in such nth student discipline database, using such nth customized database interface; and (n+1)th authorizer means for permitting at least one authorized user of such (n+1)th student discipline database to alter only data contained in such (n+1)th student discipline database, using such (n+1)th customized database interface.

In accordance with another preferred embodiment hereof, this invention provides a computer-assisted discipline tracking system, relating to tracking behavior information relating to at least one subject of at least one subject group using automatic imposition of incremented preset consequences, comprising: at least one nth discipline incident data adapted to document at least one nth behavior information related to such at least one subject; at least one (n+1)th discipline incident data adapted to document at least one (n+1)th behavior information related to such at least one subject; at least one discipline database adapted to contain such at least one nth incident data and such at least one (n+1)th discipline incident data; at least one Internet provider adapted to provide Internet access to such at least one discipline database; at least one nth consequence level adapted to identify at least one nth consequence level; at least one (n+1)th consequence level adapted to identify at least one (n+1)th consequence level; at least one nth consequence fulfillment exercise adapted to identify at least one nth consequence fulfillment exercise; at least one (n+1)th consequence fulfillment exercise adapted to identify at least one (n+1)th consequence fulfillment exercise; at least one automatic nth level associator adapted to automatically associate such at least one nth discipline incident data with such at least one nth consequence level; at least one automatic (n+1)th level associator adapted to automatically associate such at least one (n+1)th discipline incident data with such at least one (n+1)th consequence level; at least one automatic nth exercise associator adapted to automatically associate such at least one nth consequence level with such at least one nth consequence fulfillment exercise; at least one automatic (n+1)th exercise associator adapted to automatically associate such at least one (n+1)th consequence level with such at least one (n+1)th consequence fulfillment exercise; at least one data receiver adapted to receive such at least one (n+1)th discipline incident data into such at least one discipline database; at least one automatic (n+1)th level increaser adapted to automatically increase from such at least one nth consequence level to such at least one (n+1)th consequence level after such at least one data receiver receives such at least one (n+1)th discipline incident data into such at least one discipline database; at least one automatic (n+1)th exercise assigner adapted to automatically assign such at least one (n+1)th consequence fulfillment exercise to such at least one subject after such at least one automatic (n+1)th level increaser automatically increases from such at least one nth consequence level to such at least one (n+1)th consequence level; and at least one automatic (n+1)th assignment receiver adapted to automatically receive assignment data relating to such at least one (n+1)th consequence fulfillment exercise into such at least one discipline database after such at least one automatic (n+1)th exercise assigner automatically assigns such at least one (n+1)th consequence fulfillment exercise to such at least one subject.

And, it provides such a computer-assisted discipline tracking system, further comprising at least one communicator adapted to communicate such at least one (n+1)th consequence level to such at least one subject. Further, it provides such a computer-assisted discipline tracking system, further comprising at least one schedule generator, adapted to generate at least one schedule adapted to schedule performing such at least one (n+1)th consequence fulfillment exercise, and adapted to receive such at least one schedule into such at least one discipline database. Even further, it provides such a computer-assisted discipline tracking system, further comprising at least one schedule communicator adapted to communicate such at least one schedule to such at least one subject. Moreover, it provides such a computer-assisted discipline tracking system, further comprising at least one exercise data receiver adapted to receive data relating to completion of such at least one (n+1)th consequence fulfillment exercise by such at least one subject into such at least one discipline database.

Additionally, it provides such a computer-assisted discipline tracking system, further comprising: at least one automatic authority incident communicator adapted to automatically communicate such at least one (n+1)th discipline incident data to at least one authority; and at least one automatic authority schedule communicator adapted to automatically communicate such at least one (n+1)th consequence fulfillment exercise schedule to such at least one authority. Also, it provides such a computer-assisted discipline tracking system, further comprising at least one automatic authority level communicator adapted to automatically communicate such at least one (n+1)th consequence level to such at least one authority. In addition, it provides such a computer-assisted discipline tracking system, further comprising at least one automatic authority exercise communicator adapted to automatically communicate such at least one (n+1)th consequence fulfillment exercise to such at least one authority. And, it provides such a computer-assisted discipline tracking system, wherein such at least one authority comprises at least one parent. Further, it provides such a computer-assisted discipline tracking system, wherein such at least one authority comprises at least one school official.

Even further, it provides such a computer-assisted discipline tracking system, further comprising: at least one automatic remote authority incident communicator adapted to automatically communicate such at least one (n+1)th discipline incident data to at least one remote authority; at least one automatic remote authority schedule communicator adapted to automatically communicate such at least one (n+1)th consequence fulfillment exercise schedule to such at least one remote authority. Moreover, it provides such a computer-assisted discipline tracking system, further comprising at least one automatic remote authority level communicator adapted to automatically communicate such at least one (n+1)th consequence level to such at least one remote authority. Additionally, it provides such a computer-assisted discipline tracking system, further comprising at least one automatic remote authority exercise communicator adapted to automatically communicate such at least one (n+1)th consequence fulfillment exercise to such at least one remote authority.

Also, it provides such a computer-assisted discipline tracking system, wherein such at least one remote authority comprises at least one parent. In addition, it provides such a computer-assisted discipline tracking system, wherein such at least one remote authority comprises at least one school official. And, it provides such a computer-assisted discipline tracking system, wherein such automatic remote authority incident communicator comprises e-mail. Further, it provides such a computer-assisted discipline tracking system, wherein such automatic remote authority schedule communicator comprises e-mail. Even further, it provides such a computer-assisted discipline tracking system, wherein such automatic remote authority level communicator comprises e-mail. Moreover, it provides such a computer-assisted discipline tracking system, wherein such automatic remote authority exercise communicator comprises e-mail. Additionally, it provides such a computer-assisted discipline tracking system, further comprising at least one nth level programmer adapted to program at least one association between such at least one nth consequence level and such at least one nth consequence fulfillment exercise.

Also, it provides such a computer-assisted discipline tracking system, further comprising at least one (n+1)th level programmer adapted to program at least one association between such at least one (n+1)th consequence level and such at least one (n+1)th consequence fulfillment exercise. In addition, it provides such a computer-assisted discipline tracking system, wherein such at least one subject comprises at least one student. And, it provides such a computer-assisted discipline tracking system, wherein such at least one subject comprises at least one child. Further, it provides such a computer-assisted discipline tracking system, wherein such at least one subject comprises at least one inmate.

In accordance with another preferred embodiment hereof, this invention provides a computer-assisted discipline tracking system, relating to tracking behavior information relating to at least one subject of at least one subject group using automatic imposition of incremented preset consequences, comprising: at least one nth discipline incident data adapted to document at least one nth behavior information related to such at least one subject; at least one (n+1)th discipline incident data adapted to document at least one (n+1)th behavior information related to such at least one subject; at least one discipline database adapted to contain such at least one nth incident data and such at least one (n+1)th discipline incident data; at least one Internet provider adapted to provide Internet access to such at least one discipline database; at least one nth consequence level adapted to identify at least one nth consequence level; at least one (n+1)th consequence level adapted to identify at least one (n+1)th consequence level; at least one nth consequence fulfillment exercise adapted to identify at least one nth consequence fulfillment exercise; at least one (n+1)th consequence fulfillment exercise adapted to identify at least one (n+1)th consequence fulfillment exercise; at least one automatic nth level associator adapted to automatically associate such at least one nth discipline incident data with such at least one nth consequence level; at least one automatic (n+1) level associator adapted to automatically associate such at least one (n+1)th discipline incident data with such at least one (n+1)th consequence level; at least one automatic nth exercise associator adapted to automatically associate such at least one nth consequence level with such at least one nth consequence fulfillment exercise; at least one automatic (n+1)th exercise associator adapted to automatically associate such at least one (n+1)th consequence level with such at least one (n+1)th consequence fulfillment exercise; at least one data receiver adapted to receive such at least one (n+1)th discipline incident data into such at least one discipline database; at least one automatic (n+1)th level increaser adapted to automatically increase from such at least one nth consequence level to such at least one (n+1)th consequence level after such at least one data receiver receives such at least one (n+1)th discipline incident data into such at least one discipline database; at least one automatic (n+1)th exercise assigner adapted to automatically assign such at least one (n+1)th consequence fulfillment exercise to such at least one subject after such at least one automatic (n+1)th level increaser automatically increases from such at least one nth consequence level to such at least one (n+1)th consequence level; at least one automatic (n+1)th assignment receiver adapted to automatically receive assignment data relating to such at least one (n+1)th consequence fulfillment exercise into such at least one discipline database after such at least one automatic (n+1)th exercise assigner automatically assigns such at least one (n+1)th consequence fulfillment exercise to such at least one subject; and at least one fee receiver adapted to receive at least one fee relating to access to such at least one discipline database.

Even further, it provides such a computer-assisted discipline tracking system, further comprising at least one database customizer adapted to customize such at least one discipline database to accommodate user-defined discipline incident data. Even further, it provides such a computer-assisted discipline tracking system, further comprising at least one web site customizer adapted to customize such at least one Internet provider to provide at least one user-defined interface to such at least one discipline database. Even further, it provides such a computer-assisted discipline tracking system, further comprising at least one distinct database provider adapted to provide at least one distinct instance of such at least one discipline database to each of at least two distinct subject groups through such at least one internet provider. Even further, it provides such a computer-assisted discipline tracking system, further comprising at least one group web site provider adapted to provide at least one subject group internet web site to each of at least two distinct subject groups through such at least one Internet provider.

Even further, it provides such a computer-assisted discipline tracking system, further comprising at least one group discipline tracker adapted to provide at least one subject group Internet web site, and at least one subject group discipline database, to each of at least two distinct subject groups through such at least one Internet provider. Even further, it provides such a computer-assisted discipline tracking system, further comprising at least one security provider adapted to provide data security to such at least one subject group internet web site and to such at least one subject group discipline database. Even further, it provides such a computer-assisted discipline tracking system, further comprising at least one web site updater adapted to update the programming of such at least one subject group Internet web site.

Even further, it provides such a computer-assisted discipline tracking system, further comprising at least one database updater adapted to update the programming of such at least one subject group discipline database. Even further, it provides such a computer-assisted discipline tracking system, further comprising at least one analyzer adapted to perform at least one statistical analysis on data contained in at least two subject group discipline databases. Even further, it provides such a computer-assisted discipline tracking system, further comprising at least one data seller adapted to sell anonymous copies of data contained in at least two subject group discipline databases. Even further, it provides such a computer-assisted discipline tracking system, further comprising at least one backup provider adapted to provide at least one backup of data contained in at least two subject group discipline databases.

In accordance with another preferred embodiment hereof, this invention provides a behavior modification system, relating to computerized tracking of behavior data, comprising: at least one computer database adapted to provide at least one computerized database; at least one storer adapted to store past behavior data in such at least one computer database; at least one receiver adapted to receive current behavior data into such at least one computer database; at least one computerized level calculator adapted to perform computerized calculation of at least one response level based on such past behavior data and such current behavior data; at least one computerized exercise calculator adapted to perform computerized calculation of at least one reinforcement exercise based on such at least one response level; at least one computerized scheduler adapted to perform computerized scheduling of such at least one reinforcement exercise; at least one computerized reporter adapted to perform computerized reporting of such at least one reinforcement exercise; at least one computerized exercise storer adapted to store at least one record of such at least one reinforcement exercise into such at least one computer database; at least one tracking data receiver adapted to receive tracking data relating to the completion of such at least one reinforcement exercise into such at least one computer database; wherein such at least one computerized level calculator automatically increments such at least one response level upon each incidence of such at least one receiver receiving current behavior data.

In accordance with another preferred embodiment hereof, this invention provides a behavior tracking system, relating to computerized storage and manipulation of behavior data, comprising: at least one Internet server provider adapted to provide at least one Internet data server comprising at least one nth subdirectory adapted to provide at least one nth subdirectory comprising at least one nth database adapted to provide at least one nth student discipline database; at least one nth interface adapted to provide at least one nth customized database interface; and at least one (n+1)th subdirectory adapted to provide at least one (n+1)th subdirectory comprising at least one (n+1)th database adapted to provide at least one (n+1)th student discipline database; at least one (n+1)th interface adapted to provide at least one (n+1)th customized database interface; at least one nth authorizer adapted to only permit at least one authorized user of such at least one nth student discipline database to alter data contained in such at least one nth student discipline database, using such at least one nth customized database interface; and at least one (n+1)th authorizer adapted to only permit at least one authorized user of such at least one (n+1)th student discipline database to alter data contained in such at least one (n+1)th student discipline database, using such at least one (n+1)th customized database interface.

### BRIEF DESCRIPTION OF THE DRAWINGS

FIG. 1 shows a diagram illustrating the behavior management system according to a preferred embodiment of the present invention.

FIG. 2 shows a flow chart illustrating a behavior management method according to the preferred embodiment of the present invention.

FIG. 3 shows a flow chart illustrating another behavior management method according to the preferred embodiment of the present invention.

FIG. 4 shows a block diagram illustrating a further behavior management method according to the preferred embodiment of the present invention.

FIG. 5 shows a block diagram illustrating yet another behavior management method according to the preferred embodiment of the present invention.

FIG. 6 shows a diagram illustrating a behavior management computer system according to the preferred embodiment of the present invention.

FIG. 7 shows a diagram illustrating another behavior management computer system according to the preferred embodiment of the present invention.

FIG. 8 shows a diagram illustrating a further behavior management computer system according to the preferred embodiment of the present invention.

FIG. 9 shows a diagram illustrating a behavior management computer subdirectory system according to the preferred embodiment of the present invention.

FIG. 10 shows a screenshot illustrating the front page of the program according to FIG. 1.

FIG. 11 shows a screenshot illustrating the lunch detention calendar page of the program according to FIG. 1.

FIG. 12 shows a screenshot illustrating the lunch detention list page of the program according to FIG. 1.

FIG. 13 shows a screenshot illustrating the after-school detention calendar page of the program according to FIG. 1.

FIG. 14 shows a screenshot illustrating the after-school detention list page of the program according to FIG. 1.

FIG. 15 shows a screenshot illustrating the Saturday-school detention calendar page of the program according to FIG. 1.

FIG. 16 shows a screenshot illustrating the Saturday-school detention list page of the program according to FIG. 1.

FIG. 17 shows a screenshot illustrating the MATS detention calendar page of the program according to FIG. 1.

FIG. 18 shows a screenshot illustrating the MATS detention list page of the program according to FIG. 1.

FIG. 19 shows a screenshot illustrating the change password page of the program according to FIG. 1.

FIG. 20 shows a screenshot illustrating the view student lists chart page of the program according to FIG. 1.

FIG. 21 shows a screenshot illustrating the view selected student list page of the program according to FIG. 1.

FIG. 22 shows a screenshot illustrating the add students page of the program according to FIG. 1.

FIG. 23 shows a screenshot illustrating the add students confirmation page of the program according to FIG. 1.

FIG. 24 shows a screenshot illustrating the lunch detention attendance page of the program according to FIG. 1.

FIG. 25 shows a screenshot illustrating the lunch detention attendance complete page of the program according to FIG. 1.

FIG. 26 shows a screenshot illustrating the after-school detention attendance page of the program according to FIG. 1.

FIG. 27 shows a screenshot illustrating the after-school detention attendance complete page of the program according to FIG. 1.

FIG. 28 shows a screenshot illustrating the Saturday-school attendance page of the program according to FIG. 1.

FIG. 29 shows a screenshot illustrating the Saturday-school attendance complete page of the program according to FIG. 1.

FIG. 30 shows a screenshot illustrating the MATS attendance page of the program according to FIG. 1.

FIG. 31 shows a screenshot illustrating the MATS attendance complete page of the program according to FIG. 1.

FIG. 32 shows a screenshot illustrating the set-up discipline structure page of the program according to FIG. 1.

FIG. 33 shows a screenshot illustrating the set-up lunch calendar page of the program according to FIG. 1.

FIG. 34 shows a screenshot illustrating the set-up after-school calendar page of the program according to FIG. 1.

FIG. 35 shows a screenshot illustrating the set-up Saturday-school calendar page of the program according to FIG. 1.

FIG. 36 shows a screenshot illustrating the set-up MATS calendar page of the program according to FIG. 1.

FIG. 37 shows a screenshot illustrating the add user page of the program according to FIG. 1.

FIG. 38 shows a screenshot illustrating the edit user page of the program according to FIG. 1.

FIG. 39 shows a screenshot illustrating the randomly select winners page of the program according to FIG. 1.

FIG. 40 shows a screenshot illustrating the winner results page of the program according to FIG. 1.

FIG. 41 shows a screenshot illustrating the rewards by number of infractions page of the program according to FIG. 1.

FIG. 42 shows a screenshot illustrating the select grade page of the program according to FIG. 1.

FIG. 43 shows a screenshot illustrating the list of students page of the program according to FIG. 1.

FIG. 44 shows a screenshot illustrating the reward certificates page of the program according to FIG. 1.

FIG. 45 shows a screenshot illustrating the report infraction page of the program according to FIG. 1.

FIG. 46 shows a screenshot illustrating the report confirmation page of the program according to FIG. 1.

FIG. 47 shows a screenshot illustrating the student consequence notice page of the program according to FIG. 1.

FIG. 48 shows a screenshot illustrating the instant referral confirmation page of the program according to FIG. 1.

FIG. 49 shows a screenshot illustrating the immediate referral page of the program according to FIG. 1.

FIG. 50 shows a screenshot illustrating the anecdotal record page of the program according to FIG. 1.

FIG. 51 shows a screenshot illustrating the comment confirmation page of the program according to FIG. 1.

FIG. 52 shows a screenshot illustrating the view student card page of the program according to FIG. 1.

FIG. 53 shows a screenshot illustrating the delete infraction confirmation page of the program according to FIG. 1.

FIG. 54 shows a screenshot illustrating the view all discipline page of the program according to FIG. 1.

FIG. 55 shows a screenshot illustrating the add lunch detention page of the program according to FIG. 1.

FIG. 56 shows a screenshot illustrating the add after-school detention page of the program according to FIG. 1.

FIG. 57 shows a screenshot illustrating the add Saturday-school detention page of the program according to FIG. 1.

FIG. 58 shows a screenshot illustrating the add in-school suspension page of the program according to FIG. 1.

FIG. 59 shows a screenshot illustrating the consequence confirmation page of the program according to FIG. 1.

FIG. 60 shows a screenshot illustrating the student consequence notice page of the program according to FIG. 1.

FIG. 61 shows a screenshot illustrating the delete student confirmation page of the program according to FIG. 1.

### DETAILED DESCRIPTION OF THE BEST MODES AND PREFERRED EMBODIMENTS OF THE INVENTION

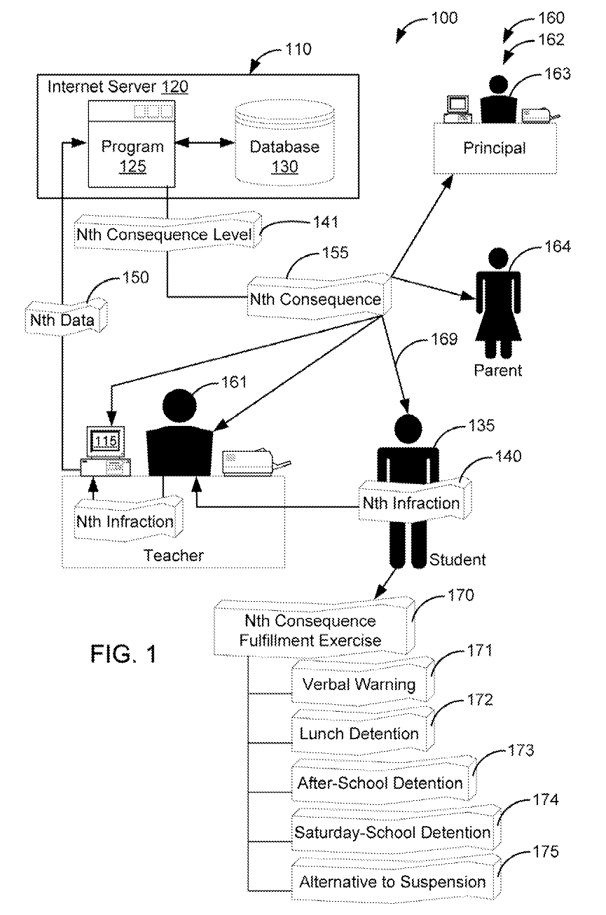

FIG. 1 shows a diagram illustrating Behavior Management System 100 according to a preferred embodiment of the present invention. Preferably, Behavior Management System 100 enables a user, who is preferably a teacher, to track the behavior of Subjects 135, who are preferably students, over time. Preferably, when a student behaves badly, the teacher records the behavior in a computer program that has a database and the computer program automatically assigns and schedules a consequence for the improper behavior. This provides teachers with a simple method of recording behavior and tracking consequences, and provides students with consequences that are objectively and fairly assigned.

Preferably, Behavior Management System 100 comprises Computer System 110, as shown. Preferably, Computer System 110 comprises Terminal 115 and Internet server 120, as shown. Preferably, Internet server 120 comprises Web Site 121, Program 125, and Database 130, as shown. Upon reading the teachings of this specification, those with ordinary skill in the art will now understand that, under appropriate circumstances, considering such issues as advances in technology, user preference, intended use, type of computer, etc., other system components, such as Intranet sites, local area network enabled programs, handheld computer terminals, cell-phone type data input devices, etc., may suffice.

Preferably, when Subject 135 commits nth Infraction 140, Local Authority 161 enters nth Infraction 140 into Database 130 through Program 125, through Web Site 121, through Internet server 120, using Terminal 115, as shown. Preferably, entering nth Infraction 140 into Database 130 generates nth Data 150, as shown. Preferably, nth Data 150 is a subset of Subject Data 151, as shown. Preferably, Subject Data 151 comprises all nth Data 150 regarding Subject 135 stored in Database 130, and all other data stored regarding Subject 135, preferably including biographical and educational data. Preferably, Program 125 uses Data 150 to automatically calculate nth Consequence 155. Preferably, Program 125 stores new nth Consequences 155 in Database 130 as additional Subject Data 151.

Preferably, Program 125 automatically communicates nth Consequence 155 to one or more Authorities 160, as shown. Preferably, Program 125 automatically e-mails nth Consequence 155 to one or more Authorities 160, as shown. Preferably, Authorities 160 comprise local Authorities 161 and/or Remote Authorities 162, as shown. Preferably, Remote Authorities 162 comprise Administrator 163 and/or Guardian 164, as shown. Preferably, Local Authority 161 comprises at least one school teacher. Preferably, Administrator 163 comprises at least one school principal. More preferably, Administrator 163 comprises at least one school vice principal. Preferably, Subject 135 comprises at least one student. Preferably, Subject 135 comprises at least one child. Preferably, Guardian 164 comprises at least one parent of Subject 135. Preferably, when Behavior Management System 100 is used in correctional institutions, Authority 160 comprises at least one corrections officer and Subject 135 comprises at least one inmate.

Preferably, nth Consequence 155 comprises nth Consequence Assignment 169 of nth Consequence Fulfillment Exercise 170 to Subject 135, as shown. Preferably, nth Consequence Fulfillment Exercise 170 comprises at least one Verbal Warning 171, as shown, preferably delivered to Subject 135 by Local Authority 161. Preferably, nth Consequence Fulfillment Exercise 170 comprises at least one Lunch Detention 172, as shown. Preferably, nth Consequence Fulfillment Exercise 170 comprises at least one After-School Detention 173, as shown. Preferably, nth Consequence Fulfillment Exercise 170 comprises at least one Saturday-School detention 174, as shown. Preferably, nth Consequence Fulfillment Exercise 170 comprises at least one Alternative to Suspension 175 (also called MATS suspension), as shown. Preferably, nth Consequence Assignment 169 comprises consequence type, time, date, and location data necessary for Subject 135 to perform nth Consequence Fulfillment Exercise 170.

Preferably, after the time of nth Consequence Fulfillment Exercise 170, Program 125 receives Fulfillment Data 177, as shown. Preferably, Fulfillment Data 177 is entered into Program 125 by Authority 160. Preferably, if Fulfillment Data 177 indicates that Subject 135 has performed nth Consequence Fulfillment Exercise 170, no further action is taken.

Preferably, if Fulfillment Data 177 indicates that Subject 135 has not performed Consequence Fulfillment Exercise 170, Program 125 automatically reschedules nth Consequence Fulfillment Exercise 170, and also automatically generates (n+1)th Data 150 which in turn automatically triggers the additional assignment of (n+1)th Consequence Fulfillment Exercise 170.

Preferably, n equals an integer number of behavior Infractions 140. Preferably, for each nth Infraction 140 at least one nth Consequence Level 141 exists, as shown. Preferably, each nth Consequence Level 141 has at least one associated nth Consequence 155, as shown. Preferably, for n=0, no behavior Infractions 140 have occurred and no Consequences 155 have been assigned to Subject 135. Preferably, for n=1, one behavior Infraction 140 has occurred and one first Consequence 155 is assigned to Subject 135. Preferably, for n=2, two behavior Infractions 140 have occurred and one second Consequence 155 is assigned to Subject 135, etc.

Preferably, the severity of the assigned nth Consequence 155 is determined by nth Consequence Level 141. Preferably, nth Consequence Level 141 is incremented according to rules in Program 125 relating the number of nth Infractions 140 entered into Database 130 with at least one nth Consequence Level 141. Preferably, nth Consequence Level 141 is incremented after one nth Infraction 140 is entered into Database 130. Preferably, nth Consequence Level 141 is incremented after two nth Infractions 140 are entered into Database 130. Preferably, nth Consequence Level 141 is incremented after three nth Infractions 140 are entered into Database 130. Preferably, nth Consequence Level 141 is incremented after four nth Infractions 140 are entered into Database 130 More preferably, nth Consequence Level 141 is incremented once after a total of three nth Infractions 140 are entered into Database 130, again after a total of six nth Infractions 140 are entered into Database 130, again after a total of nine nth Infractions 140 are entered into Database 130, etc.

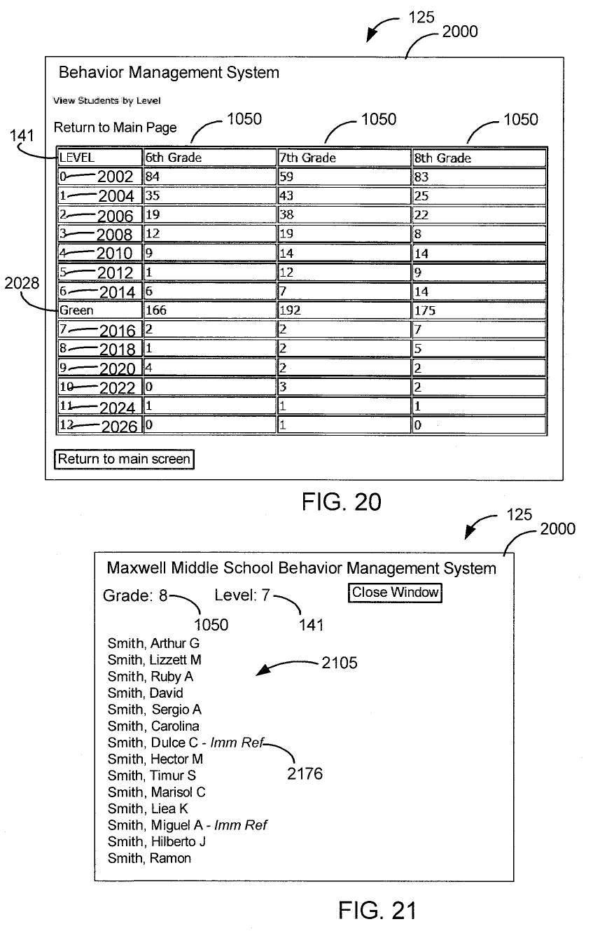

Preferably, nth Consequence Level 141 at least comprises zeroth Consequence Level 2002, first Consequence Level 2004, second Consequence Level 2006, third Consequence Level 2008, fourth Consequence Level 2010, and fifth Consequence Level 2012, as shown in FIG. 20. Preferably, for zeroth Consequence Level 180, zero nth Infractions 140 have been entered into Database 130 and nth Consequence 155 comprises no Consequences. Preferably, for first Consequence Level 181, at least one nth Infraction 140 has been entered into Database 130 and nth Consequence 155 comprises at least one Verbal Warning 171. Preferably, for second Consequence Level 182, at least four nth Infractions 140 have been entered into Database 130 and nth Consequence 155 comprises at least one Lunch Detention 172. Preferably, for third Consequence Level 183, at least seven nth Infractions 140 have been entered into Database 130 and nth Consequence 155 comprises at least one After-School Detention 173. Preferably, for fourth Consequence Level 184, at least ten nth Infractions 140 have been entered into Database 130 and nth Consequence 155 comprises at least one Saturday-School detention 174. Preferably, for fifth Consequence Level 185, at least thirteen nth Infractions 140 have been entered into Database 130 and nth Consequence 155 comprises at least one Alternative to Suspension 175.

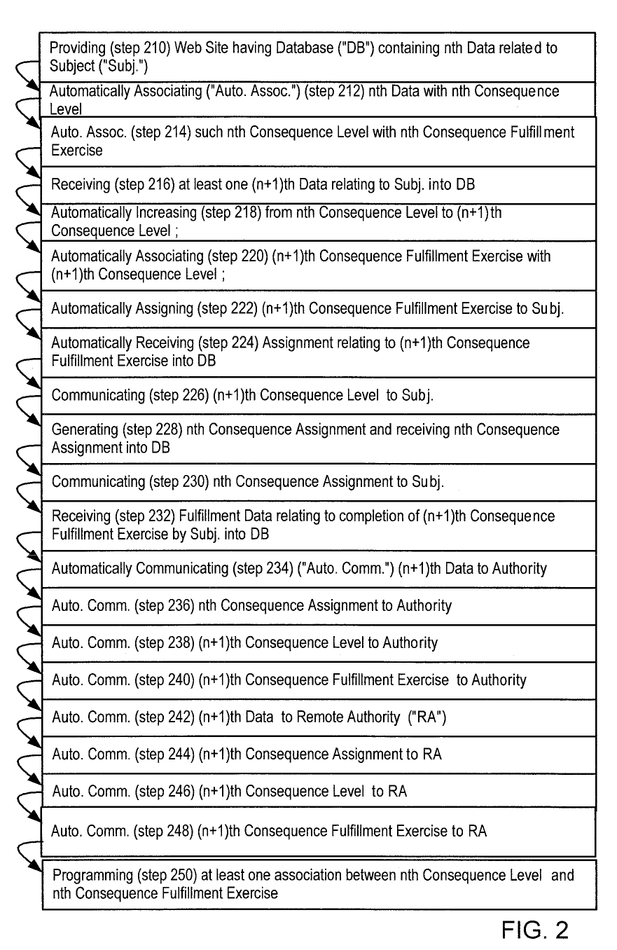

FIG. 2 shows a block diagram illustrating Behavior Management Method 200 according to the preferred embodiment of the present invention. Preferably, Behavior Management System 100 comprises Behavior Management Method 200, as shown.

Preferably, Behavior Management Method 200 comprises at least one computer-assisted discipline tracking method, relating to tracking nth Infractions 140 relating to Subject 135 of at least one Subject Group 205 using automatic imposition of nth Consequences 155, comprising the steps of: Providing (step 210) Web Site 121 having Database 130 containing nth Data 150 related to Subject 135; Automatically Associating (step 212) such nth Data 150 with nth Consequence Level 141; Automatically Associating (step 214) such nth Consequence Level 141 with nth Consequence Fulfillment Exercise 170; Receiving (step 216) at least one (n+1)th Data 150 relating to Subject 135 into Database 130; Automatically Increasing (step 218) from nth Consequence Level 141 to (n+1)th Consequence Level 141; Automatically Associating (step 220) (n+1)th Consequence Fulfillment Exercise 170 with (n+1)th Consequence Level 141; Automatically Assigning (step 222) (n+1)th Consequence Fulfillment Exercise 170 to Subject 135; and Automatically Receiving (step 224) Assignment 169 relating to (n+1)th Consequence Fulfillment Exercise 170 into Database 130, as shown.

Preferably, Behavior Management Method 200 further comprises the step of Communicating (step 226) (n+1)th Consequence Level 141 to Subject 135, as shown.

Preferably, Behavior Management Method 200 further comprises the step of Generating (step 228) nth Consequence Assignment 169 and receiving nth Consequence Assignment 169 into Database 130, as shown.

Preferably, Behavior Management Method 200 further comprises the step of Communicating (step 230) nth Consequence Assignment 169 to Subject 135, as shown.

Preferably, Behavior Management Method 200 further comprises the step of Receiving (step 232) Fulfillment Data 177 relating to completion of (n+1)th Consequence Fulfillment Exercise 170 by Subject 135 into Database 130, as shown.

Preferably, Behavior Management Method 200 further comprises the steps of Automatically Communicating (step 234) (n+1)th Data 150 to Authority 160; and Automatically Communicating (step 236) nth Consequence Assignment 169 to Authority 160, as shown. Preferably, Behavior Management Method 200 further comprises the step of Automatically Communicating (step 238) (n+1)th Consequence Level 141 to Authority 160, as shown. Preferably, Behavior Management Method 200 further comprises the step of Automatically Communicating (step 240) (n+1)th Consequence Fulfillment Exercise 170 to Authority 160, as shown.

Preferably, Behavior Management Method 200 further comprises the step of Automatically Communicating (step 242) (n+1)th Data 150 to Remote Authority 162; and Automatically Communicating (step 244) (n+1)th Consequence Assignment 169 to Remote Authority 162, as shown. Preferably, Behavior Management Method 200 further comprises the step of Automatically Communicating (step 246) (n+1)th Consequence Level 141 to Remote Authority 162, as shown. Preferably, Behavior Management Method 200 further comprises the step of Automatically Communicating (step 248) (n+1)th Consequence Fulfillment Exercise 170 to Remote Authority 162, as shown.

Preferably, Behavior Management Method 200 further comprises the step of Programming (step 250) at least one association between nth Consequence Level 141 and nth Consequence Fulfillment Exercise 170, as shown.

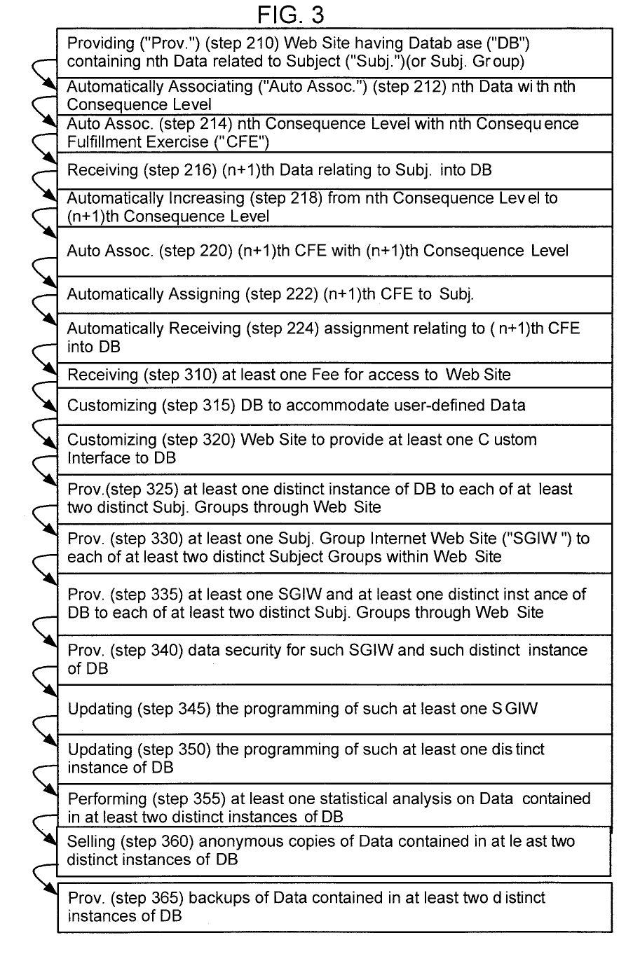

FIG. 3 shows a block diagram illustrating Behavior Management Method 300 according to the preferred embodiment of the present invention. Preferably, Behavior Management System 100 comprises Behavior Management Method 300, as shown.

Preferably, Behavior Management Method 300 comprises at least one computer-assisted discipline tracking method, relating to tracking nth Infractions 140 relating to Subject 135 of at least one Subject Group 205 using automatic imposition of nth Consequences 155, comprising the steps of: Providing (step 210) Web Site 121 having Database 130 containing nth Data 150 related to Subject 135 (or Subject Group 205); Automatically Associating (step 212) nth Data 150 with nth Consequence Level 141; Automatically Associating (step 214) nth Consequence Level 141 with nth Consequence Fulfillment Exercise 170; Receiving (step 216) (n+1)th Data 150 relating to Subject 135 into Database 130; Automatically Increasing (step 218) from nth Consequence Level 141 to (n+1)th Consequence Level 141; Automatically Associating (step 220) (n+1)th Consequence Fulfillment Exercise 170 with (n+1)th Consequence Level 141; Automatically Assigning (step 222) (n+1)th Consequence Fulfillment Exercise 170 to Subject 135; Automatically Receiving (step 224) assignment 169 relating to (n+1)th Consequence Fulfillment Exercise 170 into Database 130; and Receiving (step 310) at least one Fee 311 for access to Web Site 121, as shown.

Preferably, for the purposes of the present patent application, the term “Automatically” refers to a step or result that happens or exists through the operation of a preexisting arrangement that is triggered by some event, preferably that is accomplished without additional human effort or intervention, most preferably as a result of at least one computer program rule. Upon reading the teachings of this specification, those with ordinary skill in the art will now understand that, under appropriate circumstances, considering such issues as advances in technology, user preference, technical requirements, etc., other definitions of automatic, such as a computer-generated decision that requires human confirmation or approval, a computer-generated subset of options requiring human decision and/or authorization, a set of non-computer implemented rules, etc., may suffice.

Preferably, Behavior Management Method 300 further comprises the step of Customizing (step 315) Database 130 to accommodate user-defined Data 150, as shown. Preferably, Behavior Management Method 300 further comprises the step of Customizing (step 320) Web Site 121 to provide at least one Custom Interface 321 to Database 130, as shown. Preferably, Behavior Management Method 300 further comprises the step of Providing (step 325) at least one distinct instance of Database 130 to each of at least two distinct Subject Groups 205 through Web Site 121, as shown. Preferably, Behavior Management Method 300 further comprises the step of Providing (step 330) at least one Subject Group Internet Web Site 331 to each of at least two distinct Subject Groups 205 within Web Site 121, as shown. Preferably, Behavior Management Method 300 further comprises the step of Providing (step 335) at least one Subject Group Internet Web Site 331 and at least one distinct instance of Database 130 to each of at least two distinct Subject Groups 205 through Web Site 121, as shown.

Preferably, Behavior Management Method 300 provides each of two or more Subject Groups 205 with their own independent website and database housed in a subdirectory of the main website. Preferably, a Subject Group 205 comprises at least one school. Preferably, a Subject Group 205 comprises at least one school district. Preferably, a Subject Group 205 comprises at least one state school system. This permits the main website provider to provide, maintain, backup, and update custom databases and interfaces for each Subject Group 205 from one central location. This also permits the main website provider to access all of the custom databases and generate highly useful statistical analyses of behavior data across variety of subject groups, preferably from multiple schools in a district or state. This statistical data can be used for research proposes by the Subject Groups 205. Anonymous data that has at least had student names removed can be sold or given to appropriate interested parties for use in research. Upon reading the teachings of this specification, those with ordinary skill in the art will now understand that, under appropriate circumstances, considering such issues as advances in technology, user preference, etc., other subject groups, such as school classes, school grades, correctional institutions, etc., may suffice.

Preferably, Behavior Management Method 300 further comprises the step of Providing (step 340) data security for such at least one Subject Group Internet Web Site 331 and such at least one distinct instance of Database 130, as shown. Preferably, Behavior Management Method 300 further comprises the step of Updating (step 345) the programming of such at least one Subject Group Internet Web Site 331, as shown. Preferably, Behavior Management Method 300 further comprises the step of Updating (step 350) the programming of such at least one distinct instance of Database 130, as shown.

Preferably, Behavior Management Method 300 further comprises the step of Performing (step 355) at least one statistical analysis on Data 150 contained in at least two distinct instances of Database 130, as shown. Preferably, Behavior Management Method 300 further comprises the step of Selling (step 360) anonymous copies of Data 150 contained in at least two distinct instances of Database 130, as shown.

Preferably, Behavior Management Method 300 further comprises the step of Providing (step 365) backups of Data 150 contained in at least two distinct instances of Database 130, as shown.

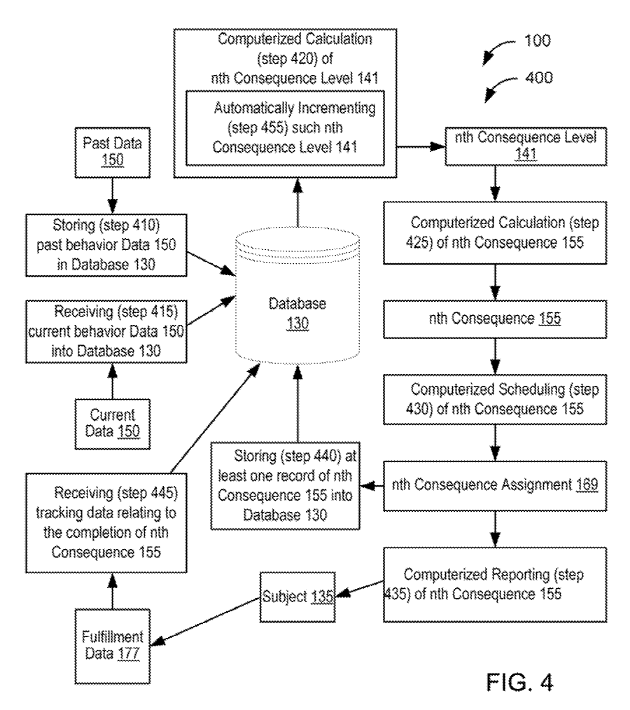

FIG. 4 shows a block diagram illustrating Behavior Management Method 400 according to the preferred embodiment of the present invention. Preferably, Behavior Management System 100 comprises Behavior Management Method 400, as shown.

Preferably, Behavior Management Method 400 comprises at least one behavior modification method, relating to computerized tracking of behavior Data 150, comprising the steps of: Storing (step 410) past behavior Data 150 in Database 130; Receiving (step 415) current behavior Data 150 into Database 130; Computerized Calculation (step 420) of nth Consequence Level 141 based on such past behavior Data 150 and such current behavior Data 150; Computerized Calculation (step 425) of nth Consequence 155 based on nth Consequence Level 141; Computerized Scheduling (step 430) of nth Consequence 155; Computerized Reporting (step 435) of nth Consequence 155 (i.e. generating nth Consequence Assignment 169); Storing (step 440) at least one record of nth Consequence 155 (i.e. storing nth Consequence Assignment 169) into Database 130; Receiving (step 445) tracking data (i.e. Fulfillment Data 177) relating to the completion of nth Consequence 155 into Database 130; wherein said step of Computerized Calculation (step 420) of nth Consequence Level 141 comprises the step of Automatically Incrementing (step 455) such nth Consequence Level 141 upon each incidence of said step of Receiving (step 415) current behavior Data 150. Upon reading the teachings of this specification, those with ordinary skill in the art will now understand that, under appropriate circumstances, considering such issues as advances in technology, user preference, etc., other steps, such as verifying consequences before implementing them, receiving data regarding the severity of the behavior infraction, selecting a consequence based on the severity of the behavior infraction, incrementing a consequence level based on the severity of the infraction, etc., may suffice.

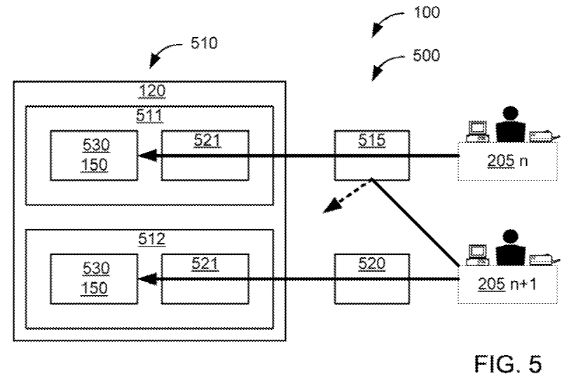

FIG. 5 shows a block diagram illustrating Behavior Management Method 500 according to the preferred embodiment of the present invention. Preferably, Behavior Management System 100 comprises Behavior Management Method 500, as shown.

Preferably, Behavior Management Method 500 comprises at least one behavior modification method, relating to computerized storage and manipulation of behavior Data 150, comprising the steps of: Providing (step 510) Internet Server 120 comprising at least one nth Subdirectory 511 comprising at least one nth Student Discipline Database 530 and at least one nth Customized Database Interface 521, and at least one (n+1)th Subdirectory 512 comprising at least one (n+1)th Student Discipline Database 530 and at least one (n+1)th Customized Database Interface 521; Permitting (step 515) at least one authorized user of such at least one nth Student Discipline Database 530 to alter only Data 150 contained in such at least one nth Student Discipline Database 530, using such at least one nth Customized Database Interface 521; and Permitting (step 520) at least one authorized user of such at least one (n+1)th Student Discipline Database 530 to alter only Data 150 contained in such at least one (n+1)th Student Discipline Database 530, using such at least one (n+1)th Customized Database Interface 521, as shown. Preferably, nth Customized Database Interface 521 comprises Program 125. Upon reading the teachings of this specification, those with ordinary skill in the art will now understand that, under appropriate circumstances, considering such issues as advances in technology, user preference, etc., other Internet server arrangements, such as a single database for all users with each group's data only accessible by password, a single interface for all users with user settings settable by each group and/or by each user, etc., may suffice.

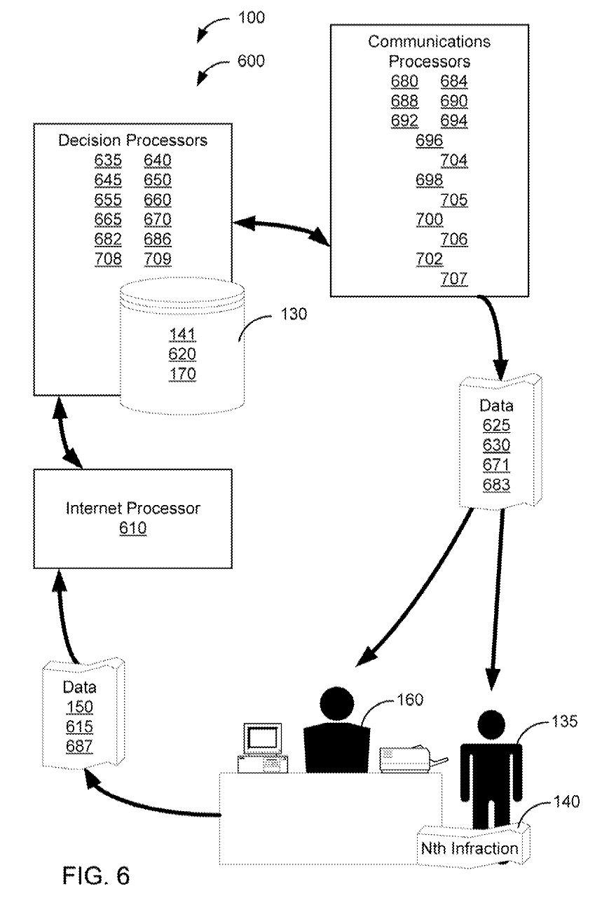

FIG. 6 shows a diagram illustrating behavior management Computer System 600 according to the preferred embodiment of the present invention. Preferably, Behavior Management System 100 comprises Computer System 600, as shown.

Preferably, Computer System 600 comprises: nth Data 150 adapted to document nth Infraction 140 related to Subject 135; (n+1)th Data 150 adapted to document (n+1)th Infraction 140 related to Subject 135; Database 130 adapted to contain nth Data 150 and (n+1)th Data 150; Internet Computer Processor 610 adapted to provide Internet access to Database 130; nth Consequence Level Data 615 (at least embodying herein at least one nth consequence level data adapted to identify at least one nth consequence level; and at least embodying herein at least one (n+1)th consequence level data adapted to identify at least one (n+1)th consequence level) adapted to identify nth Consequence Level 141; (n+1)th Consequence Level Data 620 adapted to identify (n+1)th Consequence Level 141; nth Consequence Fulfillment Exercise Data 625 (at least embodying herein at least one nth consequence fulfillment exercise data adapted to identify at least one nth consequence fulfillment exercise; and at least embodying herein at least one (n+1)th consequence fulfillment exercise data adapted to identify at least one (n+1)th consequence fulfillment exercise) adapted to identify nth Consequence Fulfillment Exercise 170; (n+1)th Consequence Fulfillment Exercise Data 630 adapted to identify (n+1)th Consequence Fulfillment Exercise 170; Automatic nth Level Data Associator Computer Processor 635 (at least embodying herein at least one automatic nth level data associator computer processor adapted to automatically associate such at least one nth discipline incident data with such at least one nth consequence level) adapted to automatically associate nth Data 150 with nth Consequence Level 141; Automatic (n+1)th Level Data Associator Computer Processor 640 (at least embodying herein at least one automatic (n+1)th level data associator computer processor adapted to automatically associate such at least one (n+1)th discipline incident data with such at least one (n+1)th consequence level) adapted to automatically associate (n+1)th Data 150 with (n+1)th Consequence Level 141; Automatic nth Exercise Data Associator Computer Processor 645 (at least embodying herein at least one automatic nth exercise data associator computer processor adapted to automatically associate such at least one nth consequence level data with such at least one nth consequence fulfillment exercise) adapted to automatically associate nth Consequence Level 141 with nth Consequence Fulfillment Exercise 170; Automatic (n+1)th Exercise Data Associator Computer Processor 650 (at least embodying herein at least one automatic (n+1)th exercise data associator computer processor adapted to automatically associate such at least one (n+1)th consequence level data with such at least one (n+1)th consequence fulfillment exercise data) adapted to automatically associate (n+1)th Consequence Level 141 with (n+1)th Consequence Fulfillment Exercise 170; Data Receiver Computer Processor 655 (at least embodying herein at least one data receiver computer processor adapted to receive such at least one (n+1)th discipline incident data into such at least one computer data storage) adapted to receive (n+1)th Data 150 into Database 130; Automatic (n+1)th Level Data Increaser Computer Processor 660 (at least embodying herein at least one automatic (n+1)th level data increaser computer processor adapted to automatically increase from such at least one nth consequence level to such at least one (n+1)th consequence level after such at least one data receiver computer processor receives such at least one (n+1)th discipline incident data into such at least one computer data storage) adapted to automatically increase from nth Consequence Level 141 (n+1)th Consequence Level 141 after Data Receiver Computer Processor 655 receives (n+1)th Data 150 into Database 130; Automatic (n+1)th Exercise Data Assigner Computer Processor 665 (at least embodying herein at least one automatic (n+1)th exercise data assigner computer processor adapted to automatically assign such at least one (n+1)th consequence fulfillment exercise to such at least one subject after such at least one automatic (n+1)th level data increaser computer processor automatically increases from such at least one nth consequence level to such at least one (n+1)th consequence level) adapted to automatically assign (n+1)th Consequence Fulfillment Exercise 170 to Subject 135 after Automatic (n+1)th Level Data Increaser Computer Processor 660 automatically increases from nth Consequence Level 141 to (n+1)th Consequence Level 141 and adapted to generate Assignment Data 671; and Automatic (n+1)th Assignment Receiver Computer Processor 670 (at least embodying herein at least one automatic (n+1)th assignment receiver computer processor adapted to automatically receive assignment data relating to such at least one (n+1)th consequence fulfillment exercise into such at least one computer data storage after such at least one automatic (n+1)th exercise data assigner computer processor automatically assigns such at least one (n+1)th consequence fulfillment exercise to such at least one subject) adapted to automatically receive Assignment Data 671 relating to (n+1)th Consequence Fulfillment Exercise 170 into Database 130 after Automatic (n+1)th Exercise Data Assigner Computer Processor 665 automatically assigns (n+1)th Consequence Fulfillment Exercise 170 to Subject 135, as shown.

Preferably, Computer System 600 further comprises Communicator Computer Processor 680 (at least embodying herein at least one communicator computer processor adapted to communicate such at least one (n+1)th consequence level to such at least one subject) adapted to communicate (n+1)th Consequence Level 141 to Subject 135, as shown.

Preferably, Computer System 600 further comprises Schedule Generator Computer Processor 682 (at least embodying herein at least one schedule generator computer processor, adapted to generate at least one (n+1)th consequence fulfillment schedule data adapted to schedule performing such at least one (n+1)th consequence fulfillment exercise, and adapted to receive such at least one (n+1)th consequence fulfillment schedule data into such at least one computer data storage), adapted to generate (n+1)th Consequence Fulfillment Schedule Data 683 adapted to schedule performing (n+1)th Consequence Fulfillment Exercise 170, and adapted to receive (n+1)th Consequence Fulfillment Schedule Data 683 into Database 130, as shown.

Preferably, Computer System 600 further comprises Schedule Communicator Computer Processor 684 (at least embodying herein at least one schedule communicator computer processor adapted to communicate such at least one schedule data to such at least one subject) adapted to communicate (n+1)th Consequence Fulfillment Schedule Data 683 to Subject 135, as shown.

Preferably, Computer System 600 further comprises Exercise Data Receiver Computer Processor 686 (at least embodying herein at least one exercise data receiver computer processor adapted to receive data relating to completion of such at least one (n+1)th consequence fulfillment exercise by such at least one subject into such at least one computer data storage) adapted to receive Completion Data 687 relating to completion of (n+1)th Consequence Fulfillment Exercise 170 by Subject 135 into Database 130, as shown.

Preferably, Computer System 600 further comprises: Automatic Authority Incident Communicator Computer Processor 688 (at least embodying herein at least one automatic authority incident communicator computer processor adapted to automatically communicate such at least one (n+1)th discipline incident data to at least one authority) adapted to automatically communicate (n+1)th Data 150 to authority 160; and Automatic Authority Schedule Communicator Computer Processor 690 (at least embodying herein at least one automatic authority schedule communicator computer processor adapted to automatically communicate such at least one (n+1)th consequence fulfillment exercise schedule data to such at least one authority) adapted to automatically communicate (n+1)th Consequence Fulfillment Schedule Data 683 to Authority 160, as shown.

Preferably, Computer System 600 further comprises Automatic Authority Level Data Communicator Computer Processor 692 (at least embodying herein at least one automatic authority level data communicator computer processor adapted to automatically communicate such at least one (n+1)th consequence level data to such at least one authority) adapted to automatically communicate (n+1)th Consequence Level 141 to Authority 160, as shown.

Preferably, Computer System 600 further comprises Automatic Authority Exercise Data Communicator Computer Processor 694 (at least embodying herein at least one automatic authority exercise data communicator computer processor adapted to automatically communicate such at least one (n+1)th consequence fulfillment exercise data to such at least one authority) adapted to automatically communicate (n+1)th Consequence Fulfillment Exercise 170 to Authority 160, as shown.

Preferably, Computer System 600 further comprises: Automatic Remote Authority incident Communicator Computer Processor 696 (at least embodying herein at least one automatic remote authority incident communicator computer processor adapted to automatically communicate such at least one (n+1)th discipline incident data to at least one remote authority) adapted to automatically communicate (n+1)th Data 150 to Remote Authority 162; and Automatic Remote Authority Schedule Communicator Computer Processor 698 (at least embodying herein at least one automatic remote authority schedule communicator computer processor adapted to automatically communicate such at least one (n+1)th consequence fulfillment exercise schedule data to such at least one remote authority) adapted to automatically communicate (n+1)th Consequence Fulfillment Schedule Data 683 to Remote Authority 162, as shown.

Preferably, Computer System 600 further comprises Automatic Remote Authority Level Data Communicator Computer Processor 700 (at least embodying herein at least one automatic remote authority level data communicator computer processor adapted to automatically communicate such at least one (n+1)th consequence level data to such at least one remote authority) adapted to automatically communicate (n+1)th Consequence Level 141 to Remote Authority 162, as shown.

Preferably, Computer System 600 further comprises Automatic Remote Authority Exercise Data Communicator Computer Processor 702 (at least embodying herein at least one automatic remote authority exercise data communicator computer processor adapted to automatically communicate such at least one (n+1)th consequence fulfillment exercise data to such at least one remote authority) adapted to automatically communicate (n+1)th Consequence Fulfillment Exercise 170 to Remote Authority 162, as shown. Preferably, Automatic Remote Authority Incident Communicator Computer Processor 696 comprises E-Mail Computer Processor 704, as shown. Preferably, Automatic Remote Authority Schedule Communicator Computer Processor 698 comprises E-Mail Computer Processor 705, as shown. Preferably, Automatic Remote Authority Level Data Communicator Computer Processor 700 comprises E-Mail Computer Processor 706, as shown. Preferably, Automatic Remote Authority Exercise Data Communicator Computer Processor 702 comprises E-Mail Computer Processor 707, as shown.

Preferably, Computer System 600 further comprises nth Level Data Programmer Computer Processor 708 (at least embodying herein at least one nth level data programmer computer processor adapted to program at least one association between such at least one nth consequence level data and such at least one nth consequence fulfillment exercise data) adapted to program at least one association between nth Consequence Level 141 and nth Consequence Fulfillment Exercise 170, as shown.

Preferably, Computer System 600 further comprises (n+1)th Level Data Programmer Computer Processor 709 (at least embodying herein at least one (n+1)th level data programmer computer processor adapted to program at least one association between such at least one (n+1)th consequence level data and such at least one (n+1)th consequence fulfillment exercise data) adapted to program at least one association between (n+1)th Consequence Level 141 and (n+1)th Consequence Fulfillment Exercise 170, as shown. Upon reading the teachings of this specification, those with ordinary skill in the art will now understand that, under appropriate circumstances, considering such issues as advances in technology, user preference, etc., other computer systems, such as other processors, other data, other databases, other relationships between consequences and consequence levels, etc., may suffice.

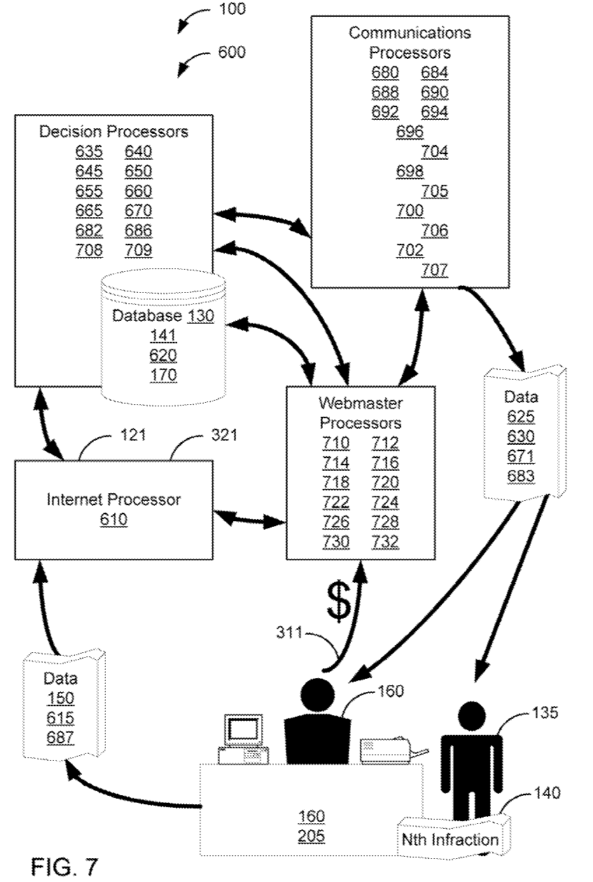

FIG. 7 shows a diagram illustrating additional elements of behavior management Computer System 600 according to the preferred embodiment of the present invention. Preferably, these additional elements provide features useful for managing, updating, and using Program 125 from the perspective of the programmer, owner, and/or webmaster.

Preferably, Computer System 600 further comprises Fee Receiver Computer Processor 710 (at least embodying herein at least one fee receiver computer processor adapted to receive at least one fee relating to access to such at least one computer data storage) adapted to receive at least one Fee 311 relating to access to Database 130, as shown.

Preferably, Computer System 600 further comprises Database Customizer Computer Processor 712 (at least embodying herein at least one database customizer computer processor adapted to customize such at least one computer data storage to accommodate user-defined discipline incident data) adapted to customize Database 130 to accommodate user-defined discipline incident Data 150, as shown.

Preferably, Computer System 600 further comprises Web Site Customizer Computer Processor 714 (at least embodying herein at least one web site customizer computer processor adapted to customize such at least one Internet computer processor to provide at least one user-defined interface computer processor to such at least one computer data storage) adapted to customize Internet Computer Processor 610 to provide at least one Custom Interface 321 to Database 130, as shown.

Preferably, Computer System 600 further comprises Distinct Database Provider Computer Processor 716 (at least embodying herein at least one distinct database provider computer processor adapted to provide at least one distinct instance of such at least one computer data storage to each of at least two distinct subject groups through such at least one Internet computer processor) adapted to provide at least one distinct instance of Database 130 to each of at least two distinct Subject Groups 205 through Internet Computer Processor 610, as shown.

Preferably, Computer System 600 further comprises Group Web Site Provider Computer Processor 718 (at least embodying herein at least one group web site provider computer processor adapted to provide at least one subject group Internet web site to each of at least two distinct subject groups through such at least one Internet computer processor) adapted to provide at least one Subject Group Web Site 121 to each of at least two distinct Subject Groups 205 through Internet Computer Processor 610, as shown.

Preferably, Computer System 600 further comprises Group Discipline Tracker Computer Processor 720 (at least embodying herein at least one group discipline tracker computer processor adapted to provide at least one subject group Internet web site, and at least one subject group computer data storage, to each of at least two distinct subject groups through such at least one Internet computer processor) adapted to provide at least one Subject Group Web Site 121, and at least one Subject Group Database 130, to each of at least two distinct Subject Groups 205 through Internet Computer Processor 610, as shown.

Preferably, Computer System 600 further comprises Security Provider Computer Processor 722 (at least embodying herein at least one security provider computer processor adapted to provide data security to such at least one subject group Internet web site and to such at least one subject group computer data storage) adapted to provide data security to such Subject Group Web Site 121 and to Subject Group Database 130, as shown.

Preferably, Computer System 600 further comprises Web Site Updater Computer Processor 724 (at least embodying herein at least one web site updater computer processor adapted to update the programming of such at least one subject group Internet web site) adapted to update the programming of such at least one Subject Group Web Site 121, as shown.

Preferably, Computer System 600 further comprises Database Updater Computer Processor 726 (at least embodying herein at least one database updater computer processor adapted to update the programming of such at least one subject group computer data storage) adapted to update the programming of Subject Group Database 130, as shown.

Preferably, Computer System 600 further comprises Analyzer Computer Processor 728 (at least embodying herein at least one analyzer computer processor adapted to perform at least one statistical analysis on data contained in at least two subject group computer data storages) adapted to perform at least one statistical analysis on Data 150 contained in at least two Subject Group Databases 130, as shown.

Preferably, Computer System 600 further comprises Data Seller Computer Processor 730 (at least embodying herein at least one data seller computer processor adapted to sell anonymous copies of data contained in at least two subject group computer data storages) adapted to sell anonymous copies of Data 150 contained in at least two Subject Group Databases 130, as shown.

Preferably, Computer System 600 further comprises Backup Provider Computer Processor 732 (at least embodying herein at least one backup provider computer processor adapted to provide at least one backup of data contained in at least two subject group computer data storages) adapted to provide at least one backup of Data 150 contained in at least two Subject Group Databases 130, as shown.

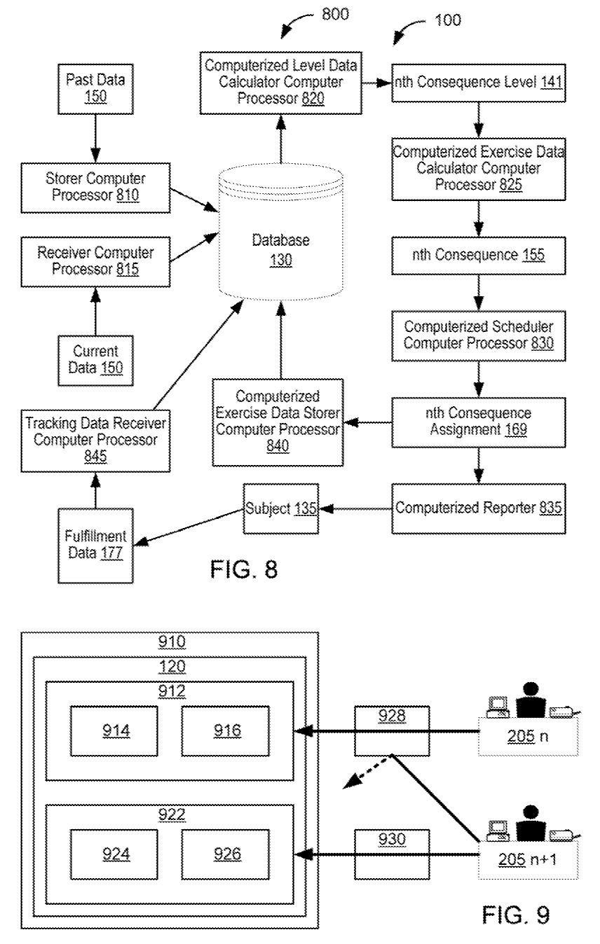

FIG. 8 shows a diagram illustrating behavior management Computer System 800 according to the preferred embodiment of the present invention. Preferably, Behavior Management System 100 comprises behavior management Computer System 800, as shown.

Preferably, behavior management Computer System 800 comprises: Database 130; storer Computer Processor 810 adapted to store past behavior Data 150 in Database 130; Receiver Computer Processor 815 adapted to receive current behavior Data 150 into Database 130; Computerized Level Data Calculator Computer Processor 820 adapted to perform computerized calculation of nth Consequence Level 141 based on such past behavior Data 150 and such current behavior Data 150; Computerized Exercise Data Calculator Computer Processor 825 adapted to perform computerized calculation of nth Consequence 155 based on nth Consequence Level 141; at least one Computerized Scheduler Computer Processor 830 adapted to perform computerized scheduling of nth Consequence 155 (generating nth Consequence Assignment 169); Computerized Reporter 835 adapted to perform computerized reporting of nth Consequence 155; Computerized Exercise Data Storer Computer Processor 840 adapted to store nth Consequence Assignment 169 into Database 130; Tracking Data Receiver Computer Processor 845 adapted to receive Fulfillment Data 177 relating to the completion of nth Consequence 155 into Database 130; wherein Computerized Level Data Calculator Computer Processor 820 automatically increments nth Consequence Level 141 upon each incidence of Receiver Computer Processor 815 receiving current behavior Data 150, as shown.

FIG. 9 shows a diagram illustrating a Behavior Management Computer Subdirectory System 900 according to the preferred embodiment of the present invention. Preferably, Behavior Management System 100 comprises Behavior Management Computer Subdirectory System 900, as shown.

Preferably, Behavior Management Computer Subdirectory System 900 comprises Internet Server Provider Computer Processor 910 adapted to provide Internet Server 120 comprising: nth Subdirectory 912 adapted to provide nth Computer Data Storage Program 914 and nth Custom Interface Program 916; (n+1)th Subdirectory 922 adapted to provide (n+1)th Computer Data Storage Program 924 and (n+1)th Custom Interface Program 926; nth Authorizer Computer Processor 928 adapted to only permit at least one authorized user of nth Computer Data Storage Program 914 to alter Data 150 contained in nth Computer Data Storage Program 914, using nth Custom Interface Program 916; and (n+1)th Authorizer Computer Processor 930 adapted to only permit at least one authorized user of (n+1)th Computer Data Storage Program 924 to alter Data 150 contained in (n+1)th Computer Data storage Program 924, using (n+1)th Custom Interface Program 926, as shown. Upon reading the teachings of this specification, those with ordinary skill in the art will now understand that, under appropriate circumstances, considering such issues as advances in technology, user preference, etc., other subdirectory systems, such as subdirectory systems having additional levels, etc., may suffice.

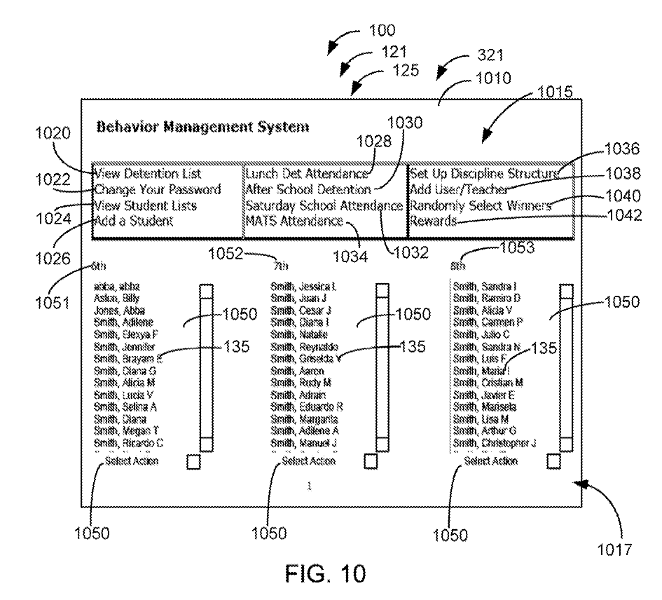

FIG. 10 shows a screenshot illustrating Front Page 1010 of Program 125 according to FIG. 1. Preferably, Internet Server 120 (at least embodying herein at least one Internet computer processor adapted to provide Internet access to such at least one computer data storage) comprises Web Site 121, Program 125, and Database 130, as shown in FIG. 1. Preferably, Web Site 121 provides access to Program 125, and Program 125 provides User Interface 321 to Data 150 contained in Database 130, as shown. Preferably, Database 130 is a relational Database, preferably a SQL Database.

Preferably, after logging in to Program 125 on Web Site 121, Front Page 1010 is displayed, as shown. Preferably, Front Page 1010 comprises Administrative Tools 1015 and Student List 1017. For the purposes of the present patent application, the term “Page” refers to an Internet web page, a program interface screen, a screenshot, an electronic document, or other user interface display.

Preferably, Administrative Tools 1015 comprise View Detention Lists Command 1020, Change Your Password Command 1022, View Student Lists Command 1024, Add a Student Command 1026, Lunch Detention Attendance Command 1028, After-School Detention Attendance Command 1030, Saturday-School Detention Attendance Command 1032, MATS Attendance Command 1034, Set Up Discipline Structure Command 1036, Add User/Teacher Command 1038, Randomly Select Winners Command 1040, and Rewards Command 1042, as shown.

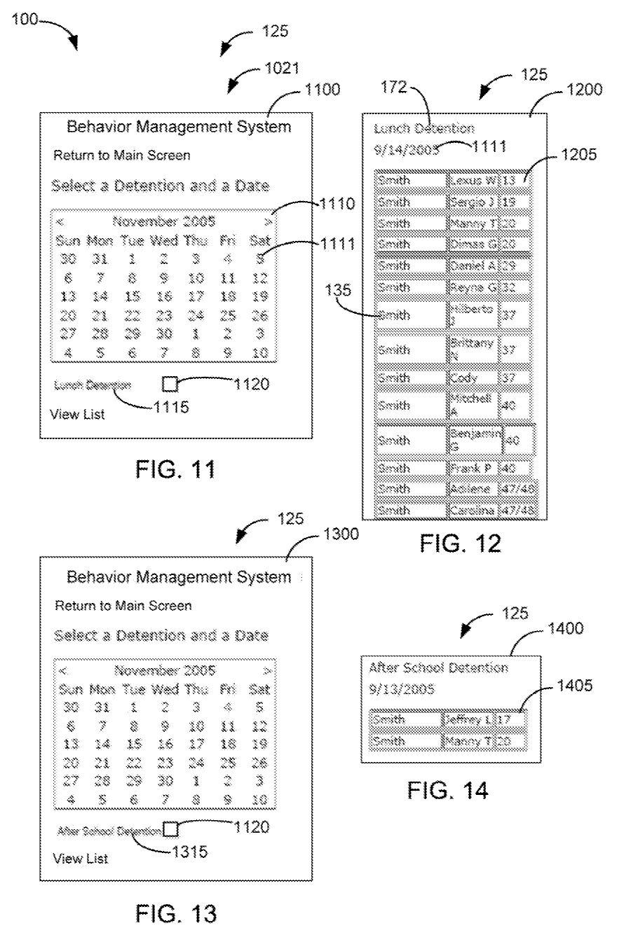

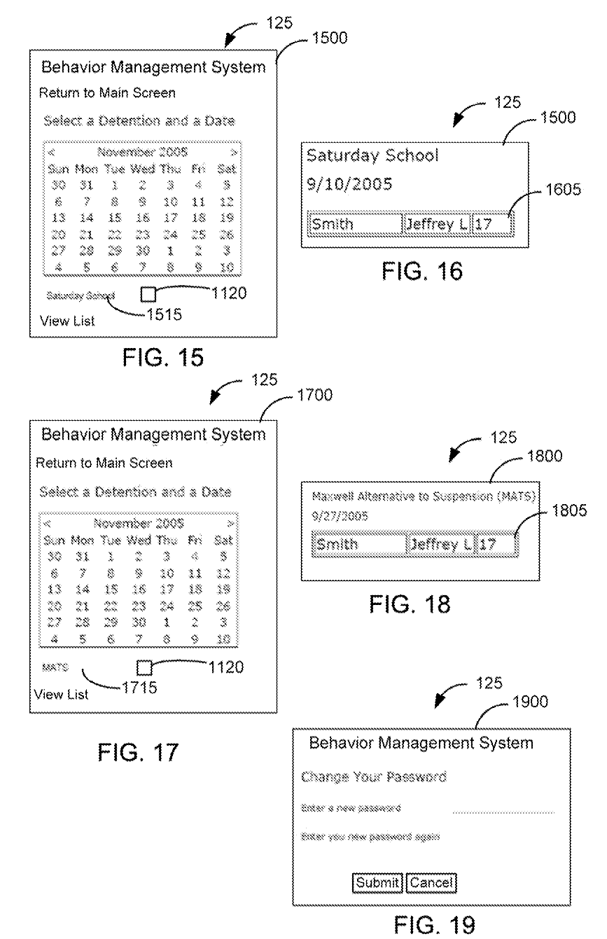

Preferably, View Detention Lists Command 1020 invokes Detention Calendar Page 1021, as shown in FIGS. 11, 13, 15, and 17. Preferably, Detention Calendar Page 1021 comprises Lunch Detention Calendar Page 1100 as shown in FIG. 11, After-School Detention Calendar Page 1300 as shown in FIG. 13, Saturday-School Detention Calendar Page 1500 as shown in FIG. 15, and MATS Detention Calendar Page 1700 as shown in FIG. 17.

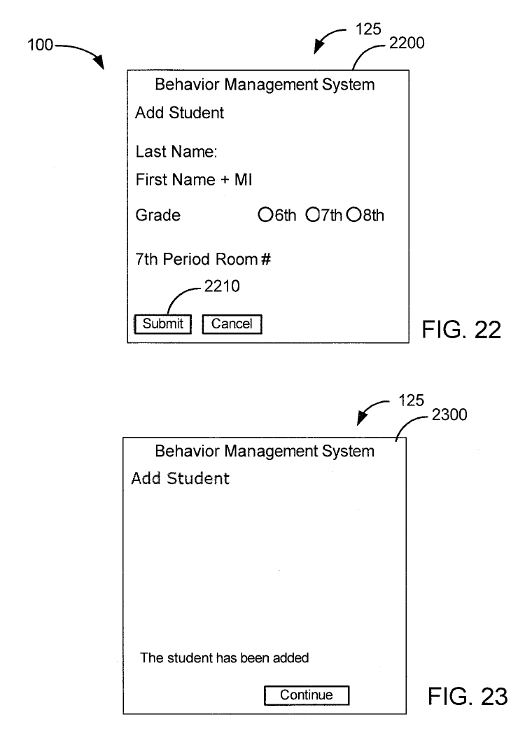

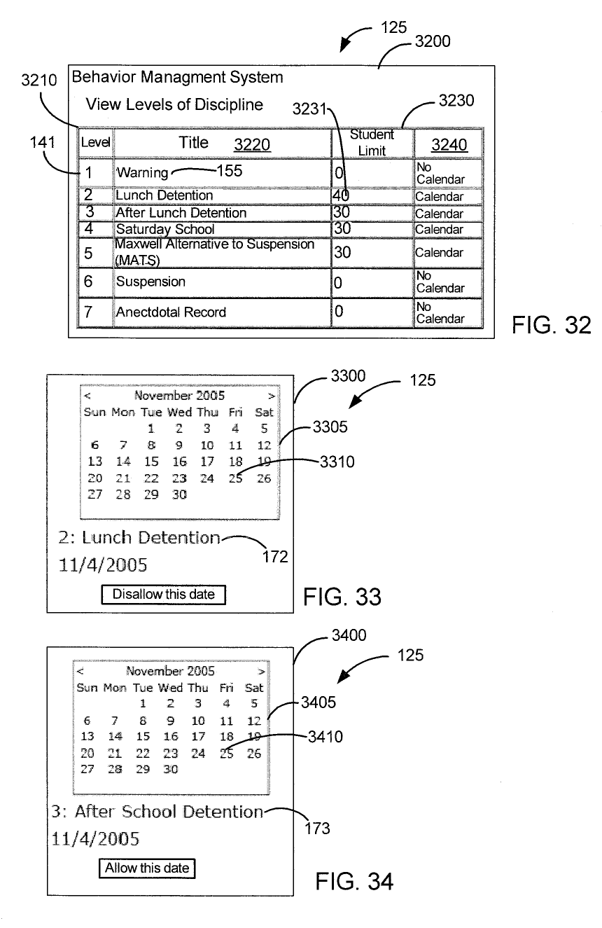

Preferably, Change Your Password Command 1022 invokes Change Password Page 1900 as shown in FIG. 19. Preferably, View Student Lists Command 1024 invokes View Student Lists Chart Page 2000 as shown in FIG. 20. Preferably, Add a Student Command 1026 invokes Add Students Page 2200 as shown in FIG. 22. Preferably, Lunch Detention Attendance Command 1028 invokes Lunch Detention Attendance Page 2400 as shown in FIG. 24. Preferably, After-School Detention Attendance Command 1030 invokes After-School Detention Attendance Page 2600 as shown in FIG. 26. Preferably, Saturday-School Detention Attendance Command 1032 invokes Saturday-School Attendance Page 2800 as shown in FIG. 28. Preferably, MATS Attendance Command 1034 invokes MATS Attendance Page 3000 as shown in FIG. 30. Preferably, Set Up Discipline Structure Command 1036 invokes Set-Up Discipline Structure Page 3200 as shown in FIG. 32.

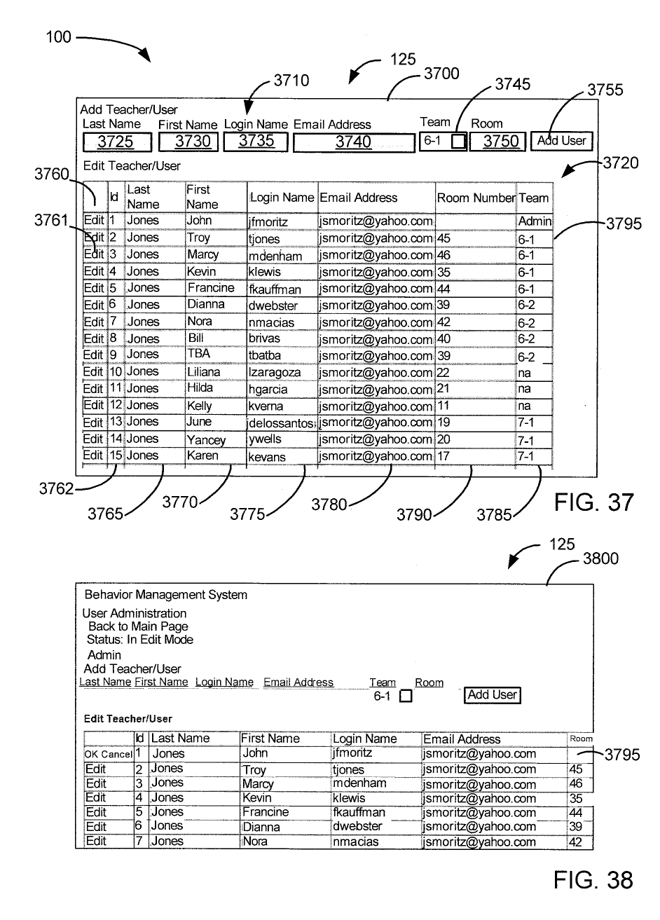

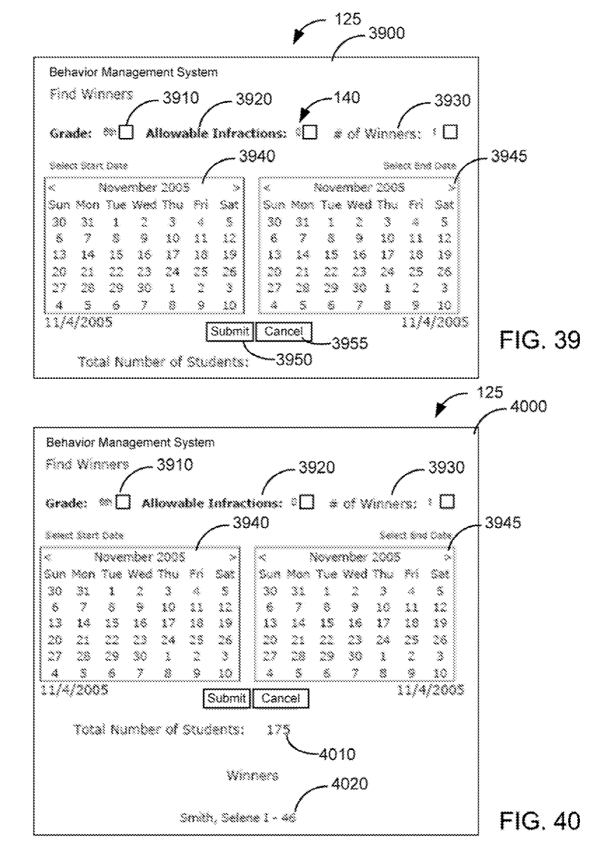

Preferably, Add User/Teacher Command 1038 invokes Add User Page 3700 as shown in FIG. 37. Preferably, Randomly Select Winners Command 1040 invokes Randomly Select Winners Page 3900 as shown in FIG. 39. Preferably, Rewards Command 1042 invokes Rewards By Number of Infractions Page 4100 as shown in FIG. 41.

Preferably, Student List 1017 comprises one or more Grade Lists 1050 with associated Select Action Commands 1055, as shown. Preferably, Grade List 1050 comprises Sixth Grade List 1051, Seventh Grade List 1052, and Eighth Grade List 1053, as shown. Preferably, Grade List 1050 comprises a list of students (aka Subjects 135) queried from Database 130, as shown. Preferably, Sixth Grade List 1051 comprises a list of sixth-grade students (aka Subjects 135) queried from Database 130, as shown. Preferably, Seventh Grade List 1052 comprises a list of seventh-grade students (aka Subjects 135) queried from Database 130, as shown. Preferably, Eighth Grade List 1053 comprises a list of eighth-grade students (aka Subjects 135) queried from Database 130.

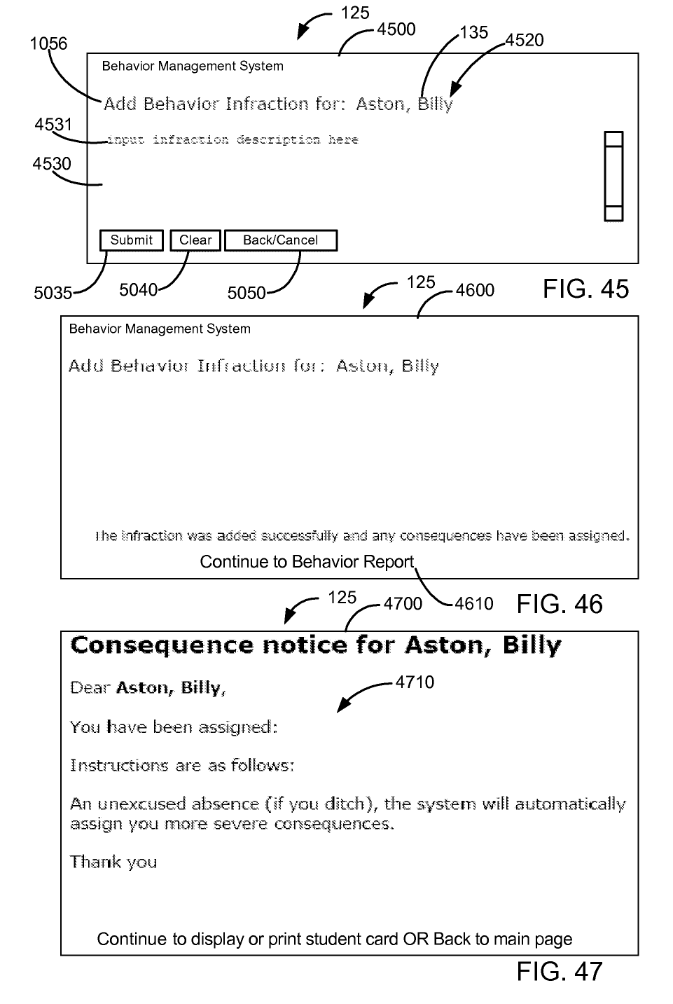

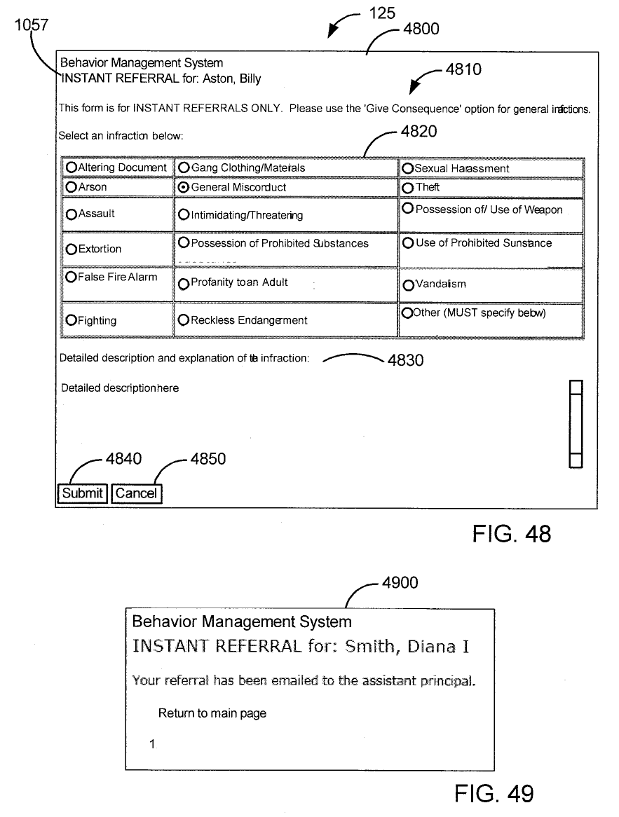

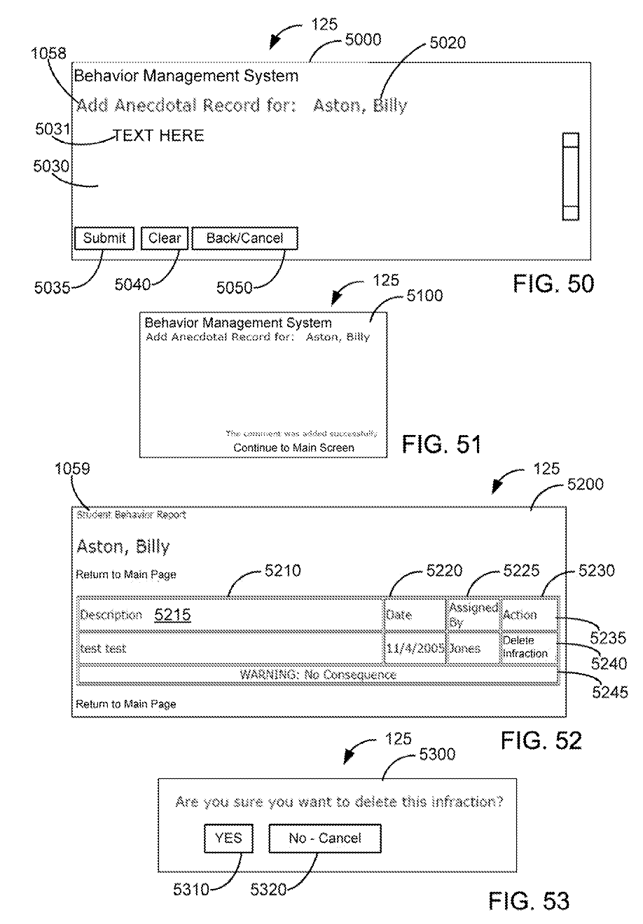

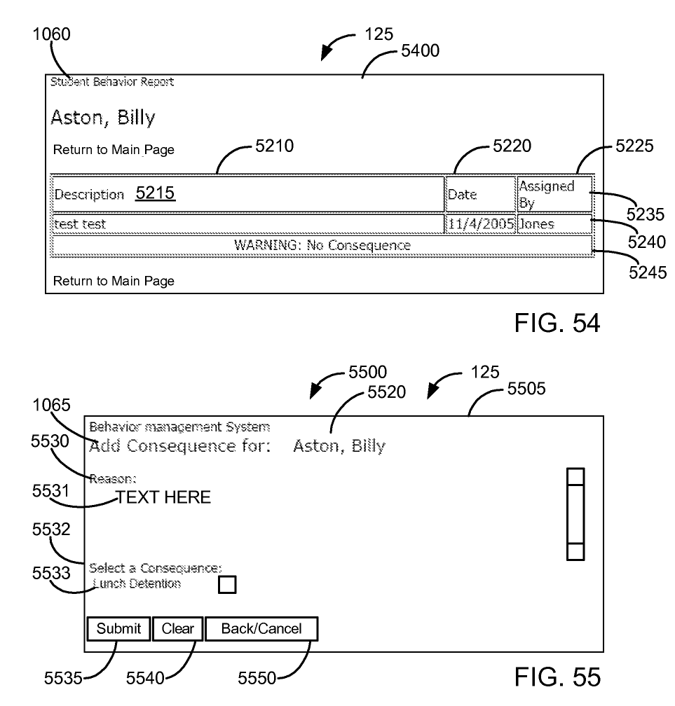

Preferably, Select Action Command 1055 comprises Report Infraction Command 1056 (as shown in FIG. 45), Immediate Referral Command 1057 (as shown in FIG. 48), Anecdotal Record Command 1058 (as shown in FIG. 50), View Student Card Command 1059 (as shown in FIG. 52), View All Discipline Command 1060 (as shown in FIG. 54), and Add Consequence Command 1065 (as shown in FIG. 55) which are preferably accessible through at least one drop-down menu.

Preferably, selecting one Subject 135 and then selecting Report Infraction Command 1056 invokes Report Infraction Page 4500 as shown in FIG. 45. Preferably, selecting one Subject 135 and then selecting Immediate Referral Command 1057 invokes Immediate Referral Page 4800 as shown in FIG. 48. Preferably, selecting one Subject 135 and then selecting Anecdotal Record Command 1058 invokes Anecdotal Record Page 5000 as shown in FIG. 50. Preferably, selecting one Subject 135 and then selecting View Student Card Command 1059 invokes View Student Card Page 5200 as shown in FIG. 52. Preferably, selecting one Subject 135 and then selecting View All Discipline Command 1060 invokes View All Discipline Page 5400 as shown in FIG. 54. Preferably, selecting one Subject 135 and then selecting Add Consequence Command 1065 invokes Add Consequence Page 5500 as shown in FIG. 55.

FIG. 11 shows a screenshot illustrating Lunch Detention Calendar Page 1100 of Program 125 according to FIG. 1. Preferably, Detention Calendar Page 1021 permits a user to select at least one Date 1111 from Calendar 1110 and to select Lunch Detention Field 1115 from Menu 1120, as shown. Preferably, when Lunch Detention Field 1115 is selected on Menu 1120, Detention Calendar Page 1021 comprises Lunch Detention Calendar Page 1100, as shown. Preferably, selecting at least one Date 1111 and selecting Lunch Detention Field 1115 from Menu 1120 invokes Lunch Detention List Page 1200 as shown in FIG. 12.

FIG. 12 shows a screenshot illustrating Lunch Detention List Page 1200 of Program 125 according to FIG. 1. Preferably, Lunch Detention List Page 1200 provides List 1205 of Subjects 135 who are scheduled for Lunch Detention 172 on the Date 1111 selected, as shown. Preferably, List 1205 is used to identify Subjects 135 who should be placed in Lunch Detention 172 on the specified Date 1111, as shown.

FIG. 13 shows a screenshot illustrating After-School Detention Calendar Page 1300 of Program 125 according to FIG. 1. Preferably, After-School Detention Calendar Page 1300 permits a user to select at least one Date 1111 from Calendar 1110 and to select After-School Detention Field 1315 from Menu 1120, as shown. Preferably, when After-School Detention Field 1315 is selected on Menu 1120, Detention Calendar Page 1021 comprises After-School Detention Calendar Page 1300, as shown. Preferably, selecting at least one Date 1111 and then selecting After-School Detention Field 1315 from Menu 1120 invokes After-School Detention List Page 1400 as shown in FIG. 14.

FIG. 14 shows a screenshot illustrating After-School Detention List Page 1400 of Program 125 according to FIG. 1. Preferably, After-School Detention List Page 1400 provides List 1405 of Subjects 135 who are scheduled for After-School Detention 173 on the Date 1111 selected, as shown. Preferably, List 1405 is used to identify Subjects 135 who should be placed in After-School Detention 173 on the specified Date 1111, as shown.

FIG. 15 shows a screenshot illustrating Saturday-School Detention Calendar Page 1500 of Program 125 according to FIG. 1. Preferably, Detention Calendar Page 1021 permits a user to select at least one Date 1111 from Calendar 1110 and to select Saturday-School Detention Field 1515 from Menu 1120, as shown. Preferably, when Saturday-School Detention Field 1515 is selected on Menu 1120, Detention Calendar Page 1021 comprises Saturday-School Detention Calendar Page 1500, as shown. Preferably, selecting at least one Date 1111 and selecting Saturday-School Detention Field 1515 from Menu 1120 invokes Saturday-School Detention List Page 1600 as shown in FIG. 16.

FIG. 16 shows a screenshot illustrating Saturday-School Detention List Page 1600 of Program 125 according to FIG. 1. Preferably, Saturday-School Detention List Page 1600 provides List 1605 of Subjects 135 who are scheduled for Saturday-School detention 174 on the Date 1111 selected, as shown. Preferably, List 1605 is used to identify Subjects 135 who should be placed in Saturday-School detention 174 on the specified Date 1111.

FIG. 17 shows a screenshot illustrating MATS Detention Calendar Page 1700 of Program 125 according to FIG. 1. Preferably, MATS Detention Calendar Page 1700 permits a user to select at least one Date 1111 from Calendar 1110 and to select MATS Detention 1715 from Menu 1120, as shown. Preferably, when MATS Detention 1715 is selected on Menu 1120, Detention Calendar Page 1021 comprises MATS Detention Calendar Page 1700, as shown. Preferably, selecting at least one Date 1111 and selecting MATS Detention 1715 from Menu 1120 invokes MATS Detention List Page 1800 as shown in FIG. 18.

FIG. 18 shows a screenshot illustrating MATS Detention List Page 1800 of Program 125 according to FIG. 1, as shown. Preferably, MATS Detention List Page 1800 provides List 1805 of Subjects 135 scheduled for Alternative to Suspension 175 (aka MATS Detention) on the Date 1111 selected, as shown. Preferably, List 1805 is used to identify Subjects 135 who should be placed in Alternative to Suspension 175 on the specified Date 1111.

FIG. 19 shows a screenshot illustrating Change Password Page 1900 of Program 125 according to FIG. 1. Preferably, Change Password Page 1900 permits an authorized user to change a password to a new password.

FIG. 20 shows a screenshot illustrating View Student Lists Chart Page 2000 Program 125 according to FIG. 1. Preferably, View Student Lists Chart Page 2000 provides a chart of how many Subjects 135 from each Grade List 1050 are in nth Consequence Level 141, as shown. Preferably, nth Consequence Level 141 comprises Zeroth Consequence Level 2002, First Consequence Level 2004, Second Consequence Level 2006, Third Consequence Level 2008, Fourth Consequence Level 2010, Fifth Consequence Level 2012, Sixth Consequence Level 2014, Seventh Consequence Level 2016, Eighth Consequence Level 2018, Ninth Consequence Level 2020, Tenth Consequence Level 2022, Eleventh Consequence Level 2024, and Twelfth Consequence Level 2026, as shown. Preferably, Zeroth Consequence Level 2002 is reserved for Subjects having zero Infractions 140.

Preferably, Subject 135 moves from a lower nth Consequence Level 141 to a higher nth Consequence Level 141 by committing a selected number of Infractions 140, as shown. Preferably, Subject 135 moves from a lower Consequence Level 141 to one higher Consequence Level 141 by committing one Infraction 140. Preferably, Subject 135 moves from a lower Consequence Level 141 to one higher Consequence Level 141 by committing two Infractions 140. Preferably, Subject 135 moves from a lower Consequence Level 141 to one higher Consequence Level 141 by committing three Infractions 140. Preferably, Subject 135 moves from a lower Consequence Level 141 to one higher Consequence Level 141 by committing four Infractions 140.

Preferably, nth Consequence Level 141 comprises Green Consequence Level 2028, as shown. Preferably, Green Consequence Level 2028 comprises Zeroth Consequence Level 2002, First Consequence Level 2004, Second Consequence Level 2006, Third Consequence Level 2008, Fourth Consequence Level 2010, Fifth Consequence Level 2012, and Sixth Consequence Level 2014, as shown. Preferably, Green Consequence Level 2028 comprises Subjects 135 having generally normally acceptable behavior. Preferably, Green Consequence Level 2028 comprises Subjects 135 having few enough nth Infractions 140 that special interventions (preferably phone calls to parents, notes home to parents, etc.) are not yet required after each additional nth Infraction 140.

Preferably, selecting one set of Subjects 135 from one Grade List 1050 and one nth Consequence Level 141 invokes View Selected Student List Page 2100 as shown in FIG. 21.

FIG. 21 shows a screenshot illustrating View Selected Student List Page 2100 Program 125 according to FIG. 1. Preferably, View Selected Student List Page 2100 provides a List 2105 of Subjects 135 in the selected Grade List 1050 and Consequence Level 141, as shown. Preferably, Subjects 135 in the selected Grade List 1050 and Consequence Level 141 are further identified to differentiate Subjects 135 who have previously received an Immediate Referral 2176 (as shown in FIG. 49).

FIG. 22 shows a screenshot illustrating Add Students Page 2200 Program 125 according to FIG. 1. Preferably, Add Students Page 2200 permits an authorized user to input a new Subject 135 into Database 130, as shown. Preferably, Add Students Page 2200 permits an authorized user to input the name, grade, and room number of Subject 135 into Database 130, as shown. Preferably, inputting the name, grade, and room number of Subject 135 into Add Students Page 2200 and selecting Submit Button 2210 inputs Subject 135 into Database 130 and invokes Add Students Confirmation Page 2300 as shown in FIG. 23.

FIG. 23 shows a screenshot illustrating Add Students Confirmation Page 2300 Program 125 according to FIG. 1. Preferably, Add Students Confirmation Page 2300 provides confirmation that Subject 135 has been successfully added to Database 130, as shown.

FIG. 24 shows a screenshot illustrating Lunch Detention Attendance Page 2400 of Program 125 according to FIG. 1. Preferably, Lunch Detention Attendance Page 2400 comprises Lunch Detention Chart 2410, as shown. Preferably, Lunch Detention Chart 2410 comprises Name Column 2412, Comment Column 2414, and Attendance Column 2416, as shown. Preferably, Name Column 2412 is automatically filled with the names of Subjects 135 who have been assigned Lunch Detention 172, as queried from Database 130. Preferably, Comment Column 2414 permits an authorized user to input a comment about the behavior of Subject 135 during Lunch Detention 172. Preferably, Attendance Column 2416 permits an authorized user to input data regarding whether Subject 135 was present for Lunch Detention 172. Preferably, the authorized user inputs “Present” into Attendance Column 2416 if Subject 135 is present during Lunch Detention 172. Preferably, the authorized user inputs “Excused” into Attendance Column 2416 if Subject 135 is absent from Lunch Detention 172 with permission. Preferably, the authorized user inputs “Absent” into Attendance Column 2416 if Subject 135 is absent from Lunch Detention 172 without permission.

Preferably, after the authorized user has filled in at least Attendance Column 2416, the authorized user selects Submit Button 2420, which preferably adds the data (Data 150) to Database 130, as shown. Preferably, for each Subject 135 who is marked “Present”, no further action is taken. Preferably, for each Subject 135 who is marked “Excused”, the current Lunch Detention 172 is automatically rescheduled for the next available date 1111 by Program 125. Preferably, for each Subject 135 who is marked “Absent”, the current Lunch Detention 172 is automatically rescheduled for the next available date 1111, another Infraction 140 is added to Database 130 for that Subject 135, and another Consequence 155 is automatically assigned to Subject 135 for the next available date 1111 after the rescheduled Lunch Detention 172 by Program 125.

FIG. 25 shows a screenshot illustrating Lunch Detention Attendance Complete Page 2500 Program 125 according to FIG. 1. Preferably, Lunch Detention Attendance Complete Page 2500 provides confirmation that Data 150 from Name Column 2412, Comment Column 2414, and Attendance Column 2416 has been submitted to Database 130, as shown.

FIG. 26 shows a screenshot illustrating After-School Detention Attendance Page 2600 Program 125 according to FIG. 1. Preferably, After-School Detention Attendance Page 2600 comprises After-School Detention Chart 2610, as shown. Preferably, After-School Detention Chart 2610 comprises Name Column 2612, Comment Column 2614, and Attendance Column 2616, as shown. Preferably, Name Column 2612 is automatically filled with the names of Subjects 135 who have been assigned After-School Detention 173, as queried from Database 130. Preferably, Comment Column 2614 permits an authorized user to input a comment about the behavior of Subject 135 during After-School Detention 173. Preferably, Attendance Column 2616 permits an authorized user to input Data 150 regarding whether Subject 135 was present for After-School Detention 173. Preferably, the authorized user inputs “Present” into Attendance Column 2616 if Subject 135 is present during After-School Detention 173. Preferably, the authorized user inputs “Excused” into Attendance Column 2616 if Subject 135 is absent from After-School Detention 173 with permission. Preferably, the authorized user inputs “Absent” into Attendance Column 2616 if Subject 135 is absent from After-School Detention 173 without permission.

Preferably, after the authorized user has filled in at least Attendance Column 2616, the authorized user selects Submit Button 2620, which preferably adds the data (Data 150) to Database 130, as shown. Preferably, for each Subject 135 who is marked “Present”, no further action is taken. Preferably, for each Subject 135 who is marked “Excused”, the current After-School Detention 173 is automatically rescheduled for the next available date 1111 by Program 125. Preferably, for each Subject 135 who is marked “Absent”, the current After-School Detention 173 is automatically rescheduled for the next available date 1111, another Infraction 140 is added to Database 130 for that Subject 135, and another Consequence 155 is automatically assigned to Subject 135 for the next available date 1111 after the rescheduled After-School Detention 173 by Program 125.

FIG. 27 shows a screenshot illustrating After-School Detention Attendance Complete Page 2700 Program 125 according to FIG. 1. Preferably, After-School Detention Attendance Complete Page 2700 provides confirmation that Data 150 from Name Column 2612, Comment Column 2614, and Attendance Column 2616 has been submitted to Database 130, as shown.

FIG. 28 shows a screenshot illustrating Saturday-School Attendance Page 2800 Program 125 according to FIG. 1. Preferably, Saturday-School Attendance Page 2800 comprises Saturday-School Detention Chart 2810, as shown. Preferably, Saturday-School Detention Chart 2810 comprises Name Column 2812, Comment Column 2814, and Attendance Column 2816, as shown. Preferably, Name Column 2812 is automatically filled with the names of Subjects 135 who have been assigned Saturday-School detention 174, as queried from Database 130, as shown. Preferably, Comment Column 2814 permits an authorized user to input a comment about the behavior of Subject 135 during Saturday-School Detention 174, as shown. Preferably, Attendance Column 2816 permits an authorized user to input Data 150 regarding whether Subject 135 was present for Saturday-School Detention 174, as shown. Preferably, the authorized user inputs “Present” into Attendance Column 2816 if Subject 135 is present during Saturday-School Detention 174. Preferably, the authorized user inputs “Excused” into Attendance Column 2816 if Subject 135 is absent from Saturday-School Detention 174 with permission. Preferably, the authorized user inputs “Absent” into Attendance Column 2816 if Subject 135 is absent from Saturday-School Detention 174 without permission.

Preferably, after the authorized user has filled in at least Attendance Column 2816, the authorized user selects Submit Button 2820, as shown, which preferably adds the data (Data 150) to Database 130. Preferably, for each Subject 135 who is marked “Present”, no further action is taken. Preferably, for each Subject 135 who is marked “Excused”, the current Saturday-School Detention 174 is automatically rescheduled for the next available date 1111 by Program 125. Preferably, for each Subject 135 who is marked “Absent”, the current Saturday-School Detention 174 is automatically rescheduled for the next available date 1111, another Infraction 140 is added to Database 130 for that Subject 135, and another Consequence 155 is automatically assigned to Subject 135 for the next available date 1111 after the rescheduled Saturday-School Detention 174 by Program 125.

FIG. 29 shows a screenshot illustrating Saturday-School Attendance Complete Page 2900 of Program 125 according to FIG. 1. Preferably, Saturday-School Attendance Complete Page 2900 provides confirmation that Data 150 from Name Column 2812, Comment Column 2814, and Attendance Column 2816 has been submitted to Database 130, as shown.

FIG. 30 shows a screenshot illustrating MATS Attendance Page 3000 Program 125 according to FIG. 1. Preferably, MATS Attendance Page 3000 comprises MATS Detention Chart 3010, as shown. Preferably, MATS Detention Chart 3010 comprises Name Column 3012, Comment Column 3014, and Attendance Column 3016, as shown. Preferably, Name Column 3012 is automatically filled with the names of Subjects 135 who have been assigned Alternative to Suspension 175 (MATS detention), as queried from Database 130, as shown. Preferably, Comment Column 3014 permits an authorized user to input a comment about the behavior of Subject 135 during Alternative to Suspension 175, as shown. Preferably, Attendance Column 3016 permits an authorized user to input Data 150 regarding whether Subject 135 was present for Alternative to Suspension 175, as shown. Preferably, the authorized user inputs “Present” into Attendance Column 3016 if Subject 135 is present during Alternative to Suspension 175. Preferably, the authorized user inputs “Excused” into Attendance Column 3016 if Subject 135 is absent from Alternative to Suspension 175 with permission. Preferably, the authorized user inputs “Absent” into Attendance Column 3016 if Subject 135 is absent from Alternative to Suspension 175 without permission.

Preferably, after the authorized user has filled in at least Attendance Column 3016, the authorized user selects Submit Button 3020, as shown, which preferably adds the data (Data 150) to Database 130. Preferably, for each Subject 135 who is marked “Present”, no further action is taken. Preferably, for each Subject 135 who is marked “Excused”, the current Alternative to Suspension 175 is automatically rescheduled for the next available date 1111 by Program 125. Preferably, for each Subject 135 who is marked “Absent”, the current Alternative to Suspension 175 is automatically rescheduled for the next available date 1111, another Infraction 140 is added to Database 130 for that Subject 135, and another Consequence 155 is automatically assigned to Subject 135 for the next available date 1111 after the rescheduled Alternative to Suspension 175 by Program 125.

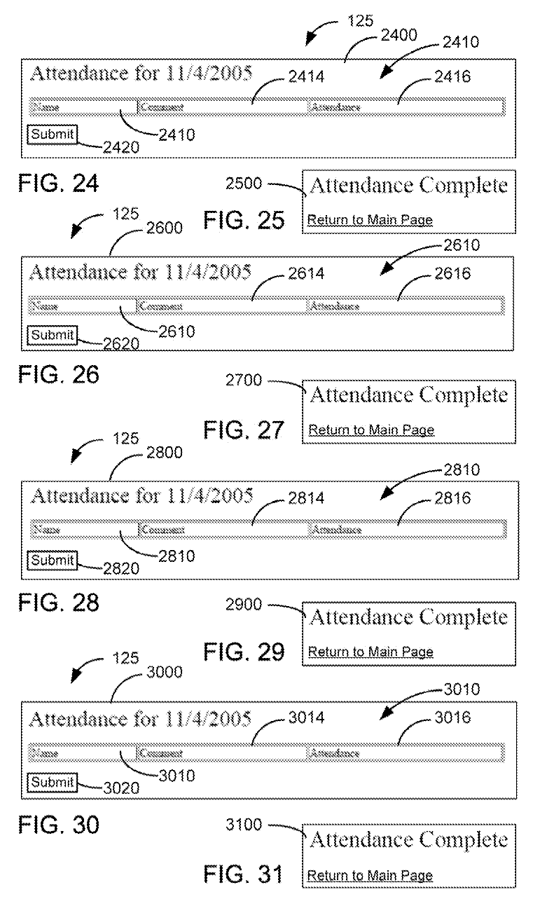

FIG. 31 shows a screenshot illustrating MATS Attendance Complete Page 3100 Program 125 according to FIG. 1. Preferably, MATS Attendance Complete Page 3100 provides confirmation that Data 150 from Name Column 3012, Comment Column 3014, and Attendance Column 3016 has been submitted to Database 130, as shown.

FIG. 32 shows a screenshot illustrating Set-Up Discipline Structure Page 3200 Program 125 according to FIG. 1. Preferably, Set-Up Discipline Structure Page 3200 comprises Level Column 3210, Title Column 3220, Student Limit Column 3230, and Calendar Access Column 3240, as shown. Preferably, Level Column 3210 comprises Consequence Levels 141 as defined by the administration in Program 125. Preferably, Title Column 3220 comprises a list of Consequences 155 associated with Consequence Levels 141 as defined by the administration in Program 125. Preferably, Student Limit Column 3230 comprises a list of the number of available Spaces 3231 in the detention classrooms that can be filled by Subjects 135 each day, as shown, as selected by the administration in Program 125. Preferably, Calendar Access Column 3240 provides access to Set-Up Lunch Calendar Page 3300, Set-Up After-School Calendar Page 3400, Set-Up Saturday-School Calendar Page 3500, and Set-Up MATS Calendar Page 3600, as shown in FIGS. 33, 34, 35, and 36, respectively.

FIG. 33 shows a screenshot illustrating Set-Up Lunch Calendar Page 3300 Program 125 according to FIG. 1. Preferably, Set-Up Lunch Calendar Page 3300 comprises a clickable Calendar 3305 which authorized users can use to select the Days 3310 on which Lunch Detentions 172 will be performed, as shown. Preferably, Program 125 will automatically schedule Subjects 135 who have been assigned Lunch Detention 172 into the selected days 3310.

FIG. 34 shows a screenshot illustrating Set-Up After-School Calendar Page 3400 Program 125 according to FIG. 1. Preferably, Set-Up After-School Calendar Page 3400 comprises a clickable Calendar 3405 which authorized users can use to select the Days 3410 on which After-School Detentions 173 will be performed, as shown. Preferably, Program 125 will automatically schedule Subjects 135 who have been assigned After-School Detention 173 into the selected Days 3410.

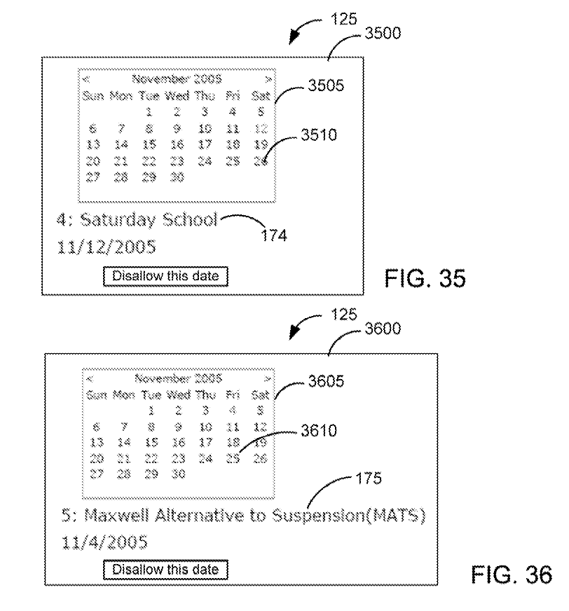

FIG. 35 shows a screenshot illustrating Set-Up Saturday-School Calendar Page 3500 Program 125 according to FIG. 1. Preferably, Set-Up Saturday-School Calendar Page 3500 comprises a clickable calendar 3505 which authorized users can use to select the Days 3510 on which Saturday-School Detentions 174 will be performed, as shown. Preferably, Program 125 will automatically schedule Subjects 135 who have been assigned Saturday-School Detention 174 into the selected Days 3510.

FIG. 36 shows a screenshot illustrating Set-Up MATS Calendar Page 3600 of Program 125 according to FIG. 1. Preferably, Set-Up MATS Calendar Page 3600 comprises a clickable calendar 3605 which authorized users can use to select the days 3610 on which alternatives to suspension 175 (MATS detentions) will be performed, as shown. Preferably, Program 125 will automatically schedule Subjects 135 who have been assigned alternatives to suspension 175 into the selected days 3610.

FIG. 37 shows a screenshot illustrating Add User Page 3700 Program 125 according to FIG. 1. Preferably, Add User Page 3700 comprises Add Users Section 3710 and Edit Users Section 3720, as shown.

Preferably, Add Users Section 3710 comprises Last Name Field 3725, First Name Field 3730, Login Name Field 3735, E-Mail Address Field 3740, Team Field 3745, Room Field 3750, and Add User Button 3755, as shown. Preferably, Last Name Field 3725 comprises the last name of a new authorized user. Preferably, First Name Field 3730 comprises the first name of the new authorized user. Preferably, Login Name Field 3735 comprises the login name of the new authorized user. Preferably, E-Mail Address Field 3740 comprises the e-mail address of the new authorized user. Preferably, Team Field 3745 comprises the team number of the new authorized user. Preferably, Room Field 3750 comprises the room number of the new authorized user. Preferably, after Add Users Section 3710 has been filled out, Add User Button 3755 is selected to add the data to Database 130.

Preferably, Edit Users Section 3720 comprises Edit Column 3760, ID Number Column 3762, Last Name Column 3765, First Name Column 3770, Login Name Column 3775, E-Mail Address Column 3780, Team Column 3785, and Room Column 3790, as shown. Preferably, selecting Edit 3761 in a particular Row 3795 of edit Column 3760 invokes Edit User Page 3800, as shown in FIG. 38.

FIG. 38 shows a screenshot illustrating Edit User Page 3800 of Program 125 according to FIG. 1. Preferably, Edit User Page 3800 is similar to Add User Page 3700, where the selected Row 3795 is now able to be modified, as shown.

FIG. 39 shows a screenshot illustrating Randomly Select Winners Page 3900 of Program 125 according to FIG. 1. Preferably, in order to reward Subjects 135 who are under a certain maximum threshold of Infractions 140, Subjects 135 are periodically selected to receive rewards. Preferably, Randomly Select Winners page 3900 comprises Grade Selector 3910, Allowable Infractions Selector 3920, Number of Winners Selector 3930, Select Start Date Calendar 3940, Select End Date Calendar 3945, Submit Button 3950, and Cancel Button 3955, as shown. Preferably, Grade Selector 3910 permits the user to select the grade from which the winner will be selected, as shown. Preferably, Allowable Infractions Selector 3920 permits the user to select the number of Subject 135 Infractions 140 (recorded as Data 150 in Database 130) comprising the maximum threshold from which winners will be selected, as shown. Preferably Number of Winners Selector 3930 permits the user to select the number of winners to be randomly chosen from among Subjects 135 from the selected grade and Infraction 140 threshold, as shown.

Preferably, selecting Cancel Button 3955 returns the user to Front Page 1010, as shown. Preferably, selecting Submit Button 3950 invokes Winner Results Page 4000 as shown in FIG. 40.

FIG. 40 shows a screenshot illustrating Winner Results Page 4000 of Program 125 according to FIG. 1. Preferably, Winner Results Page 4000 is substantially similar to Randomly Select Winners Page 3900, with the addition of the Total Number of Students 4010 from which the winner was selected, and one or more Names 4020 of the selected winners, as shown.

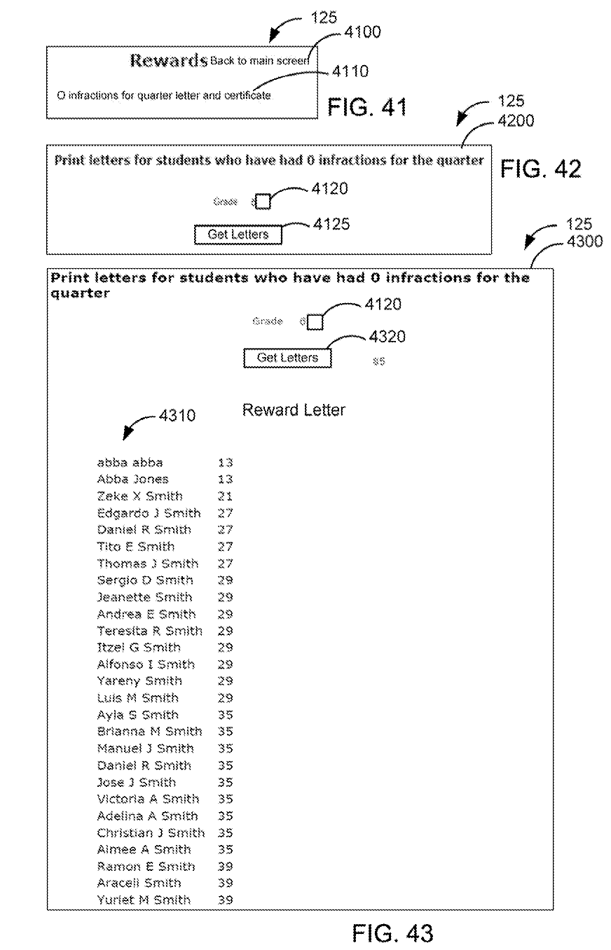

FIG. 41 shows a screenshot illustrating Rewards By Number of Infractions Page 4100 of Program 125 according to FIG. 1. Preferably, in order to reward Subjects 135 who are under a certain maximum threshold of Infractions 140, Subjects 135 are periodically selected to receive rewards, as shown. Preferably, multiple reward options are available, preferably including “Zero Infractions for Quarter Letter and Certificate” 4110, as shown. Preferably, selecting “Zero Infractions for Quarter Letter and Certificate” 4110 invokes Select Grade Page 4200 as shown in FIG. 42.

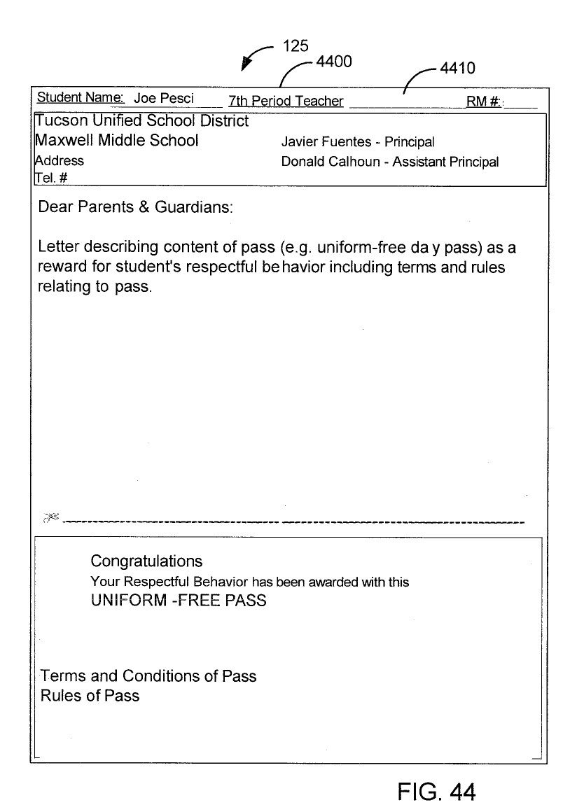

FIG. 42 shows a screenshot illustrating Select Grade Page 4200 of Program 125 according to FIG. 1. Preferably, Select Grade Page 4200 comprises Select Grade Field 4120, as shown. Preferably, Select Grade Field 4120 permits the user to select the grade for which reward certificates 4410 will be printed, as shown in FIG. 44. Preferably, selecting a grade and then selecting “Get Letters” Button 4125 invokes list of Students page 4300 as shown in FIG. 43.

FIG. 43 shows a screenshot illustrating List of Students Page 4300 of Program 125 according to FIG. 1. Preferably, List of Students Page 4300 is substantially similar to Select Grade Page 4200, with the addition of Student List 4310 and Reward Letter Button 4320, as shown. Preferably, Student List 4310 comprises the names and room numbers of Subjects 135 who are eligible for Reward Certificates 4410 as shown in FIG. 44. Preferably, selecting Reward Letter Button 4320 invokes Reward Certificates Page 4400 as shown in FIG. 44.

FIG. 44 shows a screenshot illustrating Reward Certificates Page 4400 of Program 125 according to FIG. 1. Preferably, Reward Certificates Page 4400 comprises Reward Certificate 4410, as shown. Preferably, Reward Certificates Page 4400 automatically generates Reward Certificate 4410 for each Subject 135 who is eligible, as shown. Preferably, Reward Certificate 4410 authorizes Subject 135 to a small reward, preferably a uniform free-day, as shown.

FIG. 45 shows a screenshot illustrating Report Infraction Page 4500 of Program 125 according to FIG. 1. Preferably, selecting one Subject 135 and then selecting Report Infraction Command 1056 invokes Report Infraction Page 4500, as shown. Preferably, report Infraction Page 4500 comprises Student Name Field 4520, Infraction Field 4530, Submit Button 4535, Clear Button 4540, and Cancel Button 4550, as shown. Preferably, Infraction Field 4530 receives Text 4531 typed in by the authorized user describing Infraction 140 committed by Subject 135. Preferably, Clear Button 4540 clears Text 4531 from Infraction Field 4530 without saving Text 4531. Preferably, Cancel Button 4550 returns the user to Front Page 1010. Preferably, entering Text 4531 into Infraction Field 4530 and then selecting Submit Button 4535 stores Text 4531 as Data 150 to Database 130 and invokes Report Confirmation Page 4600 as shown in FIG. 46.

FIG. 46 shows a screenshot illustrating Report Confirmation Page 4600 Program 125 according to FIG. 1. Preferably, Report Confirmation Page 4600 informs the user that Data 150 has been successfully added to Database 130 and also informs the user that Automatic Consequences 155 for Infraction 140 have been assigned to Subject 135 and stored in Database 130, as shown. Preferably, selecting “Continue to Behavior Report” Button 4610 invokes Student Consequence Notice Page 4700 as shown in FIG. 47.

FIG. 47 shows a screenshot illustrating Student Consequence Notice Page 4700 of Program 125 according to FIG. 1. Preferably, Student Consequence Notice Page 4700 comprises Consequence Notice 4710, as shown. Preferably, Consequence Notice 4710 informs Subject of the Consequence 155 that has been assigned and informs Subject 135 how to fulfill Consequence 155. Preferably, Consequence notice 4710 can be printed out and given to Subject 135 as a reminder.

FIG. 48 shows a screenshot illustrating Immediate Referral Page 4800 of Program 125 according to FIG. 1. Preferably, selecting one Subject 135 and then selecting Immediate Referral Command 1057 invokes Immediate Referral Page 4800, as shown. Preferably, Immediate Referral Page 4800 comprises Immediate Referral Form 4810, as shown. Preferably, Immediate Referral Form 4810 comprises Infraction Selector 4820, Detailed Description 4830, Submit Button 4840, and Cancel Button 4850, as shown. Preferably, Immediate Referral Form 4810 is used to bypass the usual Consequence Levels 141 and report a serious Infraction 140 directly to Remote Authority 162. Preferably, after filling in Infraction Selector 4820 and Detailed Description 4830, the user selects Submit Button 4840 to add Data 150 to Database 130, and preferably to automatically e-mail Immediate Referral Form 4810 to Remote Authority 162. Preferably, Remote Authority 162 comprises a school vice principal.

FIG. 49 shows a screenshot illustrating Instant Referral Confirmation Page 4900 of Program 125 according to FIG. 1. Preferably, Instant Referral Confirmation Page 4900 provides confirmation that Immediate Referral Form 4810 has been e-mailed to Remote Authority 162 and has been saved to Database 130, as shown.

FIG. 50 shows a screenshot illustrating Anecdotal Record Page 5000 of Program 125 according to FIG. 1. Preferably, selecting one Subject 135 and then selecting Anecdotal Record Command 1058 invokes Anecdotal Record Page 5000 as shown in FIG. 50. Preferably, Anecdotal Record Page 5000 provides users with a method of entering anecdotal comments into Database 130 without automatically incrementing Consequence Level 141.

Preferably, Anecdotal Record Page 5000 comprises student Name Field 5020, Comment Field 5030, Submit Button 5035, Clear Button 5040, and Cancel Button 5050, as shown. Preferably, Comment Field 5030 receives Text 5031 typed in by the authorized user describing the behavior of Subject 135, as shown. Preferably, Clear Button 5040 clears Text 5031 from Comment Field 5030 without saving Text 5031 to Database 130, as shown. Preferably, Cancel Button 5050 returns the user to Front Page 1010, as shown. Preferably, entering Text 5031 into Comment Field 5030 and then selecting Submit Button 5035 stores Text 5031 as Data 150 to Database 130 and invokes Comment Confirmation Page 5100 as shown in FIG. 51.

FIG. 51 shows a screenshot illustrating Comment Confirmation Page 5100 of Program 125 according to FIG. 1. Preferably, Comment Confirmation Page 5100 provides confirmation that Text 5031 has been saved to Database 130, as shown.

FIG. 52 shows a screenshot illustrating View Student Card Page 5200 of Program 125 according to FIG. 1. Preferably, selecting one Subject 135 and then selecting View Student Card Command 1059 invokes View Student Card Page 5200 as shown in FIG. 52. Preferably, View Student Card Page 5200 comprises Student Card 5210, as shown. Preferably, Student Card 5210 comprises Description Column 5215, Date Column 5220, Assigned by Column 5225, and Action Column 5230, as shown. Preferably, Student Card 5210 comprises Header Row 5235, Infraction Row 5240, and Consequence Row 5245, as shown. Preferably, each Infraction Row 5240 comprises one Infraction 140, as shown, comprising one instance of Data 150 stored in Database 130. Preferably, Consequence row 5245 lists the Consequence 155 assigned to Subject 135 for Infraction 140 listed in Infraction Row 5240, as shown. Preferably, Date Column 5220 provides the date on which Infraction 140 occurred, as shown. Preferably, Assigned by Column 5225 provides the name of Authority 160 who input Infraction 140 into Database 130, as shown. Preferably, Action Column 5230 comprises Delete Infraction Command 5232 which provides an authorized user with a method of deleting Infraction Row 5240 from Database 130, as shown. Preferably, when Delete Infraction Command 5232 is selected, Delete Infraction Confirmation Page 5300 is invoked as shown in FIG. 53.

FIG. 53 shows a screenshot illustrating Delete Infraction Confirmation Page 5300 of Program 125 according to FIG. 1. Preferably, Delete Infraction Confirmation Page 5300 requires the authorized user to confirm that Infraction Row 5240 should be deleted by selecting “Yes” Button 5310, as shown. Preferably, selecting “No-Cancel” Button 5320 returns the authorized user to View Student Card Page 5200 without deleting Infraction Row 5240.

FIG. 54 shows a screenshot illustrating View All Discipline Page 5400 of Program 125 according to FIG. 1. Preferably, selecting one Subject 135 and then selecting View All Discipline Command 1060 invokes View All Discipline Page 5400 as shown in FIG. 54. Preferably, View All Discipline Page 5400 is substantially similar to View Student Card Page 5200 but without Action Column 5230, as shown.

FIG. 55 shows a screenshot illustrating Add Lunch Detention Page 5505 of Program 125 according to FIG. 1. Preferably, selecting one Subject 135 and then selecting Add Consequence Command 1065 invokes Add Consequence Page 5500 as shown in FIG. 55. Preferably, Add Consequence Page 5500 is used by Remote Authority 162 to add nth Consequences 155 to Subject 135 independently of nth Infractions 140 under special circumstances.

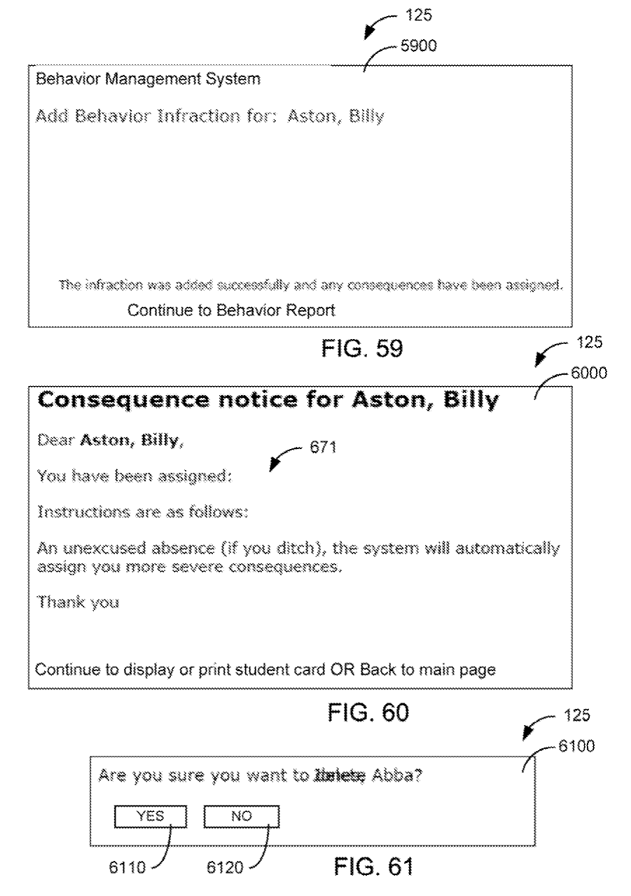

Preferably, Add Consequence Page 5500 comprises Add Lunch Detention Page 5505, as shown. Preferably, Add Lunch Detention Page 5505 comprises Student Name Field 5520, Infraction Field 5530, Consequence Menu 5532, Submit Button 5535, Clear Button 5540, and Cancel Button 5550, as shown. Preferably, for Add Lunch Detention Page 5505, Consequence Menu 5532 is set to Lunch Detention 5533, as shown. Preferably, Infraction Field 5530 receives Text 5531 typed in by the authorized user describing the behavior Infraction 140 committed by Subject 135, as shown. Preferably, Clear Button 5540 clears Text 5531 from Infraction Field 5530 without saving Text 5531. Preferably, cancel Button 5550 returns the user to Front Page 1010. Preferably, entering Text 5531 into Infraction Field 5530 and then selecting Submit Button 5535 stores Text 5531 as Data 150 to Database 130 and invokes Consequence Confirmation Page 5900 as shown in FIG. 59.

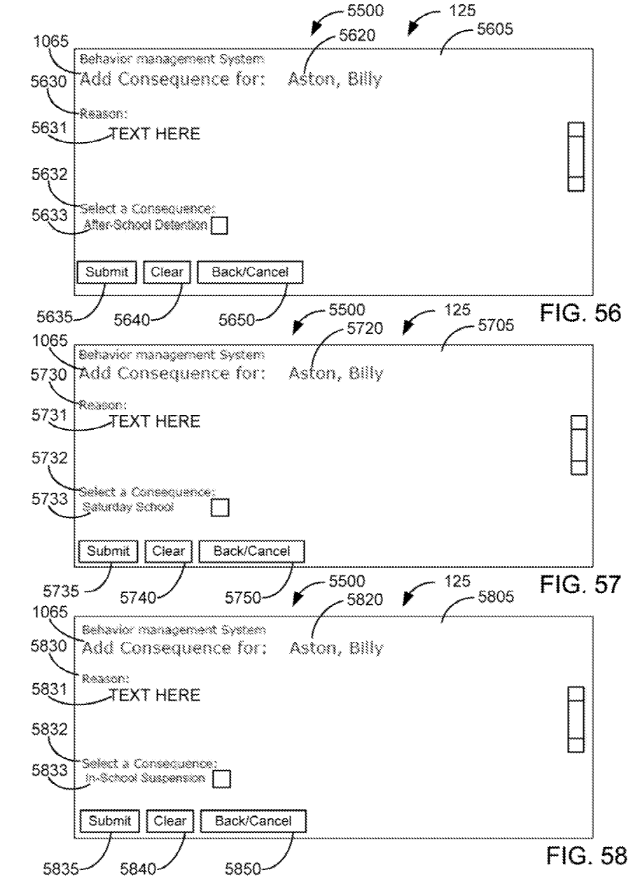

FIG. 56 shows a screenshot illustrating Add After-School Detention Page 5605 of Program 125 according to FIG. 1. Preferably, selecting one Subject 135 and then selecting Add Consequence Command 1065 invokes Add Consequence Page 5500 as shown in FIG. 55. Preferably, Add Consequence Page 5500 comprises Add After-School Detention Page 5605, as shown. Preferably, Add After-School Detention Page 5605 comprises Student Name Field 5620, Infraction Field 5630, Consequence Menu 5632, Submit Button 5635, Clear Button 5640, and Cancel Button 5650, as shown. Preferably, for Add After-School Detention Page 5605, Consequence Menu 5632 is set to After-School Detention Field 5633, as shown. Preferably, Infraction Field 5630 receives Text 5631 typed in by the authorized user describing the behavior Infraction 140 committed by Subject 135, as shown. Preferably, Clear Button 5640 clears Text 5631 from Infraction Field 5630 without saving Text 5631. Preferably, Cancel Button 5650 returns the user to Front Page 1010. Preferably, entering Text 5631 into Infraction Field 5630 and then selecting Submit Button 5635 stores Text 5631 as Data 150 to Database 130 and invokes Consequence Confirmation Page 5900 as shown in FIG. 59.

FIG. 57 shows a screenshot illustrating Add Saturday-School Detention Page 5705 of Program 125 according to FIG. 1. Preferably, selecting one Subject 135 and then selecting Add Consequence Command 1065 invokes Add Consequence Page 5500 as shown in FIG. 55. Preferably, Add Consequence Page 5500 comprises Add Saturday-School Detention Page 5705, as shown. Preferably, Add Saturday-School Detention Page 5705 comprises Student Name Field 5720, Infraction Field 5730, Consequence Menu 5732, Submit Button 5735, Clear Button 5740, and Cancel Button 5750, as shown. Preferably, for Add Saturday-School Detention Page 5705, Consequence Menu 5732 is set to Saturday-School Detention 5733, as shown. Preferably, Infraction Field 5730 receives Text 5731 typed in by the authorized user describing the behavior Infraction 140 committed by Subject 135, as shown. Preferably, Clear Button 5740 clears Text 5731 from Infraction Field 5730 without saving Text 5731. Preferably, Cancel Button 5750 returns the user to Front Page 1010. Preferably, entering Text 5731 into Infraction Field 5730 and then selecting Submit Button 5735 stores Text 5731 as Data 150 to Database 130 and invokes Consequence Confirmation Page 5900 as shown in FIG. 59.

FIG. 58 shows a screenshot illustrating Add In-School Suspension Page 5805 of Program 125 according to FIG. 1. Preferably, selecting one Subject 135 and then selecting Add Consequence Command 1065 invokes Add Consequence Page 5500 as shown in FIG. 55. Preferably, Add Consequence Page 5500 comprises Add In-School Suspension Page 5805, as shown. Preferably, Add In-School Suspension Page 5805 comprises Student Name Field 5820, Infraction Field 5830, Consequence Menu 5832, Submit Button 5835, Clear Button 5840, and Cancel Button 5850, as shown. Preferably, for Add In-School Suspension Page 5805, Consequence Menu 5832 is set to In-School Detention 5833, as shown. Preferably, Infraction Field 5830 receives Text 5831 typed in by the authorized user describing the behavior Infraction 140 committed by Subject 135, as shown. Preferably, Clear Button 5840 clears Text 5831 from Infraction Field 5830 without saving Text 5831. Preferably, Cancel Button 5850 returns the user to Front Page 1010. Preferably, entering Text 5831 into Infraction Field 5830 and then selecting Submit Button 5835 stores Text 5831 as Data 150 to Database 130 and invokes Consequence Confirmation Page 5900 as shown in FIG. 59.

FIG. 59 shows a screenshot illustrating Consequence Confirmation Page 5900 of Program 125 according to FIG. 1. Preferably, Consequence Confirmation Page 5900 informs the user that Data 150 (at least embodying herein at least one nth discipline incident data adapted to document at least one nth behavior information related to such at least one subject; and at least embodying herein at least one (n+1)th discipline incident data adapted to document at least one (n+1)th behavior information related to such at least one subject) has been successfully added to Database 130 (at least embodying herein at least one computer data storage adapted to contain such at least one nth incident data and such at least one (n+1)th discipline incident data) and also informs the user that automatic Consequences 155 for Infraction 140 have been assigned to Subject 135 and stored in Database 130.

FIG. 60 shows a screenshot illustrating Student Consequence Notice Page 6000 of Program 125 according to FIG. 1. Preferably, Student Consequence Notice Page 6000 provides Subject 135 with information regarding nth Consequence 155, as shown. Preferably, Student Consequence Notice Page 6000 provides Assignment Data 671 relating to nth Consequence Fulfillment Exercise 170 from Database 130 after Automatic nth Exercise Data Assigner Computer Processor 655 automatically assigns nth Consequence Fulfillment Exercise 170 to Subject 135.

FIG. 61 shows a screenshot illustrating Delete Student Confirmation Page 6100 of Program 125 according to FIG. 1. Preferably, Delete Student Confirmation Page 6100 requires the authorized user to confirm that Subject 135 should be deleted from Database 130 by selecting “Yes” 6110, as shown. Preferably, selecting “No” 6120 returns the authorized user to Front Page 1010 without deleting Subject 135. Upon reading the teachings of this specification, those with ordinary skill in the art will now understand that, under appropriate circumstances, considering such issues as advances in technology, user preference, intended use, type of computer, type of computer network, etc., other database interface programs having other arrangements, such as other page arrangements, different types of menus, different aesthetic arrangements, etc., may suffice.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A computer-assisted discipline tracking method, relating to tracking at least one discipline incident relating to at least one subject of at least one subject group using automatic imposition of multiple preset incident consequences, comprising the steps of:
a) providing at least one Internet web site having at least one discipline database containing at least one nth discipline incident data related to such at least one subject;
b) automatically associating such at least one nth discipline incident data with at least one nth consequence level;
c) automatically associating such at least one nth consequence level with at least one nth consequence fulfillment exercise;
d) receiving at least one (n+1)th discipline incident data relating to such at least one subject into such at least one discipline database;
e) automatically increasing from such at least one nth consequence level to at least one (n+1)th consequence level;
f) automatically associating at least one (n+1)th consequence fulfillment exercise with such at least one (n+1)th consequence level;
g) automatically assigning such at least one (n+1)th consequence fulfillment exercise to such at least one subject; and
h) automatically receiving assignment data relating to such at least one (n+1)th consequence fulfillment exercise into such at least one discipline database.

2) The computer-assisted discipline tracking method, according to claim 1, further comprising the step of communicating such at least one (n+1)th consequence level to such at least one subject.

3) The computer-assisted discipline tracking method, according to claim 1, further comprising the steps of generating at least one schedule relating to performing such at least one (n+1)th consequence fulfillment exercise and receiving such at least one schedule into such at least one discipline database.

4) The computer-assisted discipline tracking method, according to claim 3, further comprising the step of communicating such at least one schedule to such at least one subject.

5) The computer-assisted discipline tracking method, according to claim 3, further comprising the step of receiving data relating to completion of such at least one (n+1)th consequence fulfillment exercise by such at least one subject into such at least one discipline database.

6) The computer-assisted discipline tracking method, according to claim 3, further comprising the steps of:
a) automatically communicating such at least one (n+1)th discipline incident data to at least one authority; and
b) automatically communicating such at least one (n+1)th consequence fulfillment exercise schedule to such at least one authority.

7) The computer-assisted discipline tracking method, according to claim 3, further comprising the step of automatically communicating such at least one (n+1)th consequence level to such at least one authority.

8) The computer-assisted discipline tracking method, according to claim 3, further comprising the step of automatically communicating such at least one (n+1)th consequence fulfillment exercise to such at least one authority.

9) The computer-assisted discipline tracking method, according to claim 1, further comprising the steps of:
a) automatically communicating such at least one (n+1)th discipline incident data to at least one remote authority; and
b) automatically communicating such at least one (n+1)th consequence fulfillment exercise schedule to such at least one remote authority.

10) The computer-assisted discipline tracking method, according to claim 9, further comprising the step of automatically communicating such at least one (n+1)th consequence level to such at least one remote authority.

11) The computer-assisted discipline tracking method, according to claim 9, further comprising the step of automatically communicating such at least one (n+1)th consequence fulfillment exercise to such at least one remote authority.

12) The computer-assisted discipline tracking method, according to claim 1, further comprising the step of programming at least one association between such at least one nth consequence level and such at least one nth consequence fulfillment exercise.

13) A computer-assisted discipline tracking method, relating to tracking at least one discipline incident relating to at least one subject of at least one subject group using automatic imposition of multiple preset incident consequences, comprising the steps of:
a) providing at least one Internet web site, having at least one discipline database containing at least one nth discipline incident data related to such at least one subject, and adapted to perform the steps of
i) automatically associating such at least one nth discipline incident data with at least one nth consequence level;
ii) automatically associating such at least one nth consequence level with at least one nth consequence fulfillment exercise;
iii) receiving at least one (n+1)th discipline incident data relating to such at least one subject into such at least one discipline database;
iv) automatically increasing from such at least one nth consequence level to at least one (n+1)th consequence level;
v) automatically associating at least one (n+1)th consequence fulfillment exercise with such at least one (n+1)th consequence level;
vi) automatically assigning such at least one (n+1)th consequence fulfillment exercise to such at least one subject; and
vii) automatically receiving assignment data relating to such at least one (n+1)th consequence fulfillment exercise into such at least one discipline database; and
b) receiving at least one fee for access to such at least one Internet web site.

14) The computer-assisted discipline tracking method, according to claim 13, further comprising the step of customizing such at least one discipline database to accommodate user-defined discipline incident data.

15) The computer-assisted discipline tracking method, according to claim 13, further comprising the step of customizing such at least one Internet web site to provide at least one user-defined interface to such at least one discipline database.

16) The computer-assisted discipline tracking method, according to claim 13, further comprising the step of providing at least one distinct instance of such at least one discipline database to each of at least two distinct subject groups through such at least one Internet web site.

17) The computer-assisted discipline tracking method, according to claim 13, further comprising the step of providing at least one subject group Internet web site to each of at least two distinct subject groups within such at least one Internet web site.

18) The computer-assisted discipline tracking method, according to claim 13, further comprising the step of providing at least one subject group Internet web site and at least one subject group discipline database to each of at least two distinct subject groups through such at least one Internet web site.

19) The computer-assisted discipline tracking method, according to claim 18, further comprising the step of providing data security for such at least one subject group Internet web site and such at least one subject group discipline database.

20) The computer-assisted discipline tracking method, according to claim 18, further comprising the step of updating the programming of such at least one subject group Internet web site.

21) The computer-assisted discipline tracking method, according to claim 18, further comprising the step of updating the programming of such at least one subject group discipline database.

22) The computer-assisted discipline tracking method, according to claim 18, further comprising the step of performing at least one statistical analysis on data contained in at least two subject group discipline databases.

23) The computer-assisted discipline tracking method, according to claim 18, further comprising the step of selling anonymous copies of data contained in at least two subject group discipline databases.

24) The computer-assisted discipline tracking method, according to claim 18, further comprising the step of providing backups of data contained in at least two subject group discipline databases.

25) A behavior modification method, relating to computerized tracking of behavior data, comprising the steps of:
a) storing past behavior data in at least one computer database;
b) receiving current behavior data into such at least one computer database;
c) computerized calculation of at least one response level based on such past behavior data and such current behavior data;
d) computerized calculation of at least one reinforcement exercise based on such at least one response level;
e) computerized scheduling of such at least one reinforcement exercise;
f) computerized reporting of such at least one reinforcement exercise;
g) storing at least one record of such at least one reinforcement exercise into such at least one computer database; and
h) receiving tracking data relating to the completion of such at least one reinforcement exercise into such at least one computer database;
i) wherein said step of computerized calculation of at least one response level comprises the step of automatically incrementing such at least one response level upon each incidence of said step of receiving current behavior data.

26) A behavior tracking system, relating to computerized storage and manipulation of behavior data, comprising the steps of:
a) providing at least one Internet data server comprising
i) at least one nth subdirectory comprising
(1) at least one nth student discipline database;
(2) at least one nth customized database interface; and
ii) at least one (n+1)th subdirectory comprising
(1) at least one (n+1)th student discipline database;
(2) at least one (n+1)th customized database interface;
b) permitting at least one authorized user of such at least one nth student discipline database to alter only data contained in such at least one nth student discipline database, using such at least one nth customized database interface; and
c) permitting at least one authorized user of such at least one (n+1)th student discipline database to alter only data contained in such at least one (n+1)th student discipline database, using such at least one (n+1)th customized database interface.

27) A computer-assisted discipline tracker, relating to tracking behavior information relating to at least one subject of at least one subject group using automatic imposition of incremented preset consequences, comprising:
a) at least one nth discipline incident data adapted to document at least one nth behavior information related to such at least one subject;
b) at least one (n+1)th discipline incident data adapted to document at least one (n+1)th behavior information related to such at least one subject;
c) at least one computer data storage adapted to contain said at least one nth incident data and said at least one (n+1)th discipline incident data;
d) at least one Internet computer processor adapted to provide Internet access to said at least one computer data storage;
e) at least one nth consequence level data adapted to identify at least one nth consequence level;
f) at least one (n+1)th consequence level data adapted to identify at least one (n+1)th consequence level;
g) at least one nth consequence fulfillment exercise data adapted to identify at least one nth consequence fulfillment exercise;
h) at least one (n+1)th consequence fulfillment exercise data adapted to identify at least one (n+1)th consequence fulfillment exercise;
i) at least one automatic nth level data associator computer processor adapted to automatically associate said at least one nth discipline incident data with said at least one nth consequence level;
j) at least one automatic (n+1)th level data associator computer processor adapted to automatically associate said at least one (n+1)th discipline incident data with said at least one (n+1)th consequence level;
k) at least one automatic nth exercise data associator computer processor adapted to automatically associate said at least one nth consequence level data with said at least one nth consequence fulfillment exercise;
l) at least one automatic (n+1)th exercise data associator computer processor adapted to automatically associate said at least one (n+1)th consequence level data with said at least one (n+1)th consequence fulfillment exercise data;
m) at least one data receiver computer processor adapted to receive said at least one (n+1)th discipline incident data into said at least one computer data storage;
n) at least one automatic (n+1)th level data increaser computer processor adapted to automatically increase from said at least one nth consequence level to said at least one (n+1)th consequence level after said at least one data receiver computer processor receives said at least one (n+1)th discipline incident data into said at least one computer data storage;
o) at least one automatic (n+1)th exercise data assigner computer processor adapted to automatically assign said at least one (n+1)th consequence fulfillment exercise to such at least one subject after said at least one automatic (n+1)th level data increaser computer processor automatically increases from said at least one nth consequence level to said at least one (n+1)th consequence level; and
p) at least one automatic (n+1)th assignment receiver computer processor adapted to automatically receive assignment data relating to said at least one (n+1)th consequence fulfillment exercise into said at least one computer data storage after said at least one automatic (n+1)th exercise data assigner computer processor automatically assigns said at least one (n+1)th consequence fulfillment exercise to such at least one subject.

28) The computer-assisted discipline tracker, according to claim 27, further comprising at least one communicator computer processor adapted to communicate said at least one (n+1)th consequence level to such at least one subject.

29) The computer-assisted discipline tracker, according to claim 27, further comprising at least one schedule generator computer processor, adapted to generate at least one (n+1)th consequence fulfillment schedule data adapted to schedule performing said at least one (n+1)th consequence fulfillment exercise, and adapted to receive said at least one (n+1)th consequence fulfillment schedule data into said at least one computer data storage.

30) The computer-assisted discipline tracker, according to claim 29, further comprising at least one schedule communicator computer processor adapted to communicate said at least one schedule data to such at least one subject.

31) The computer-assisted discipline tracker, according to claim 29, further comprising at least one exercise data receiver computer processor adapted to receive data relating to completion of said at least one (n+1)th consequence fulfillment exercise by such at least one subject into said at least one computer data storage.

32) The computer-assisted discipline tracker, according to claim 29, further comprising:
a) at least one automatic authority incident communicator computer processor adapted to automatically communicate said at least one (n+1)th discipline incident data to at least one authority; and
b) at least one automatic authority schedule communicator computer processor adapted to automatically communicate said at least one (n+1)th consequence fulfillment exercise schedule data to such at least one authority.

33) The computer-assisted discipline tracker, according to claim 32, further comprising at least one automatic authority level data communicator computer processor adapted to automatically communicate said at least one (n+1)th consequence level data to such at least one authority.

34) The computer-assisted discipline tracker, according to claim 32, further comprising at least one automatic authority exercise data communicator computer processor adapted to automatically communicate said at least one (n+1)th consequence fulfillment exercise data to such at least one authority.

35) The computer-assisted discipline tracker, according to claim 32, wherein such at least one authority comprises at least one parent.

36) The computer-assisted discipline tracker, according to claim 32, wherein such at least one authority comprises at least one school official.

37) The computer-assisted discipline tracker, according to claim 29, further comprising:
a) at least one automatic remote authority incident communicator computer processor adapted to automatically communicate said at least one (n+1)th discipline incident data to at least one remote authority; and
b) at least one automatic remote authority schedule communicator computer processor adapted to automatically communicate said at least one (n+1)th consequence fulfillment exercise schedule data to such at least one remote authority.

38) The computer-assisted discipline tracker, according to claim 37, further comprising at least one automatic remote authority level data communicator computer processor adapted to automatically communicate said at least one (n+1)th consequence level data to such at least one remote authority.

39) The computer-assisted discipline tracker, according to claim 37, further comprising at least one automatic remote authority exercise data communicator computer processor adapted to automatically communicate said at least one (n+1)th consequence fulfillment exercise data to such at least one remote authority.

40) The computer-assisted discipline tracker, according to claim 37, wherein such at least one remote authority comprises at least one parent.

41) The computer-assisted discipline tracker, according to claim 37, wherein such at least one remote authority comprises at least one school official.

42) The computer-assisted discipline tracker, according to claim 37, wherein said automatic remote authority incident communicator computer processor comprises at least one e-mail computer processor.

43) The computer-assisted discipline tracker, according to claim 37, wherein said automatic remote authority schedule communicator computer processor comprises at least one e-mail computer processor.

44) The computer-assisted discipline tracker, according to claim 37, wherein said automatic remote authority level data communicator computer processor comprises at least one e-mail computer processor.

45) The computer-assisted discipline tracker, according to claim 37, wherein said automatic remote authority exercise data communicator computer processor comprises at least one e-mail computer processor.

46) The computer-assisted discipline tracker, according to claim 27, further comprising at least one nth level data programmer computer processor adapted to program at least one association between said at least one nth consequence level data and said at least one nth consequence fulfillment exercise data.

47) The computer-assisted discipline tracker, according to claim 27, further comprising at least one (n+1)th level data programmer computer processor adapted to program at least one association between said at least one (n+1)th consequence level data and said at least one (n+1)th consequence fulfillment exercise data.

48) A computer-assisted discipline tracker, relating to tracking behavior information relating to at least one subject of at least one subject group using automatic imposition of incremented preset consequences, comprising:
a) at least one nth discipline incident data adapted to document at least one nth behavior information related to such at least one subject;
b) at least one (n+1)th discipline incident data adapted to document at least one (n+1)th behavior information related to such at least one subject;
c) at least one computer data storage adapted to contain said at least one nth incident data and said at least one (n+1)th discipline incident data;
d) at least one Internet computer processor adapted to provide Internet access to said at least one computer data storage;
e) at least one nth consequence level data adapted to identify at least one nth consequence level;
f) at least one (n+1)th consequence level data adapted to identify at least one (n+1)th consequence level;
g) at least one nth consequence fulfillment exercise data adapted to identify at least one nth consequence fulfillment exercise;
h) at least one (n+1)th consequence fulfillment exercise data adapted to identify at least one (n+1)th consequence fulfillment exercise;
i) at least one automatic nth level data associator computer processor adapted to automatically associate said at least one nth discipline incident data with said at least one nth consequence level data;
j) at least one automatic (n+1) level data associator computer processor adapted to automatically associate said at least one (n+1)th discipline incident data with said at least one (n+1)th consequence level data;
k) at least one automatic nth exercise data associator computer processor adapted to automatically associate said at least one nth consequence level data with said at least one nth consequence fulfillment exercise data;
l) at least one automatic (n+1)th exercise data associator computer processor adapted to automatically associate said at least one (n+1)th consequence level data with said at least one (n+1)th consequence fulfillment exercise data;
m) at least one data receiver computer processor adapted to receive said at least one (n+1)th discipline incident data into said at least one computer data storage;
n) at least one automatic (n+1)th level data increaser computer processor adapted to automatically increase from said at least one nth consequence level to said at least one (n+1)th consequence level after said at least one data receiver computer processor receives said at least one (n+1)th discipline incident data into said at least one computer data storage;
o) at least one automatic (n+1)th exercise data assigner computer processor adapted to automatically assign said at least one (n+1)th consequence fulfillment exercise to such at least one subject after said at least one automatic (n+1)th level data increaser computer processor automatically increases from said at least one nth consequence level to said at least one (n+1)th consequence level;
p) at least one automatic (n+1)th assignment receiver computer processor adapted to automatically receive assignment data relating to said at least one (n+1)th consequence fulfillment exercise into said at least one computer data storage after said at least one automatic (n+1)th exercise data assigner computer processor automatically assigns said at least one (n+1)th consequence fulfillment exercise to such at least one subject; and
q) at least one fee receiver computer processor adapted to receive at least one fee relating to access to said at least one computer data storage.

49) The computer-assisted discipline tracker, according to claim 48, further comprising at least one database customizer computer processor adapted to customize said at least one computer data storage to accommodate user-defined discipline incident data.

50) The computer-assisted discipline tracker, according to claim 48, further comprising at least one web site customizer computer processor adapted to customize said at least one Internet computer processor to provide at least one user-defined interface computer processor to said at least one computer data storage.

51) The computer-assisted discipline tracker, according to claim 48, further comprising at least one distinct database provider computer processor adapted to provide at least one distinct instance of said at least one computer data storage to each of at least two distinct subject groups through said at least one Internet computer processor.

52) The computer-assisted discipline tracker, according to claim 48, further comprising at least one group web site provider computer processor adapted to provide at least one subject group Internet web site to each of at least two distinct subject groups through said at least one internet computer processor.

53) The computer-assisted discipline tracker, according to claim 48, further comprising at least one group discipline tracker computer processor adapted to provide at least one subject group Internet web site, and at least one subject group computer data storage, to each of at least two distinct subject groups through said at least one Internet computer processor.

54) The computer-assisted discipline tracker, according to claim 53, further comprising at least one security provider computer processor adapted to provide data security to such at least one subject group Internet web site and to such at least one subject group computer data storage.

55) The computer-assisted discipline tracker, according to claim 53, further comprising at least one web site updater computer processor adapted to update the programming of such at least one subject group Internet web site.

56) The computer-assisted discipline tracker, according to claim 53, further comprising at least one database updater computer processor adapted to update the programming of such at least one subject group computer data storage.

57) The computer-assisted discipline tracker, according to claim 53, further comprising at least one analyzer computer processor adapted to perform at least one statistical analysis on data contained in at least two subject group computer data storages.

58) The computer-assisted discipline tracker, according to claim 53, further comprising at least one data seller computer processor adapted to sell anonymous copies of data contained in at least two subject group computer data storages.

59) The computer-assisted discipline tracker, according to claim 53, further comprising at least one backup provider computer processor adapted to provide at least one backup of data contained in at least two subject group computer data storages.

60) A behavior modification system, relating to computerized tracking of behavior data, comprising:
a) at least one computer data storage adapted to provide at least one computerized database;
b) at least one storer computer processor adapted to store past behavior data in said at least one computer data storage;
c) at least one receiver computer processor adapted to receive current behavior data into said at least one computer data storage;
d) at least one computerized level data calculator computer processor adapted to perform computerized calculation of at least one response level based on such past behavior data and such current behavior data;
e) at least one computerized exercise data calculator computer processor adapted to perform computerized calculation of at least one reinforcement exercise based on said at least one response level;
f) at least one computerized scheduler computer processor adapted to perform computerized scheduling of said at least one reinforcement exercise;
g) at least one computerized reporter adapted to perform computerized reporting of said at least one reinforcement exercise;
h) at least one computerized exercise data storer computer processor adapted to store at least one record of said at least one reinforcement exercise into said at least one computer data storage; and
i) at least one tracking data receiver computer processor adapted to receive tracking data relating to the completion of said at least one reinforcement exercise into said at least one computer data storage;
j) wherein said at least one computerized level data calculator computer processor automatically increments said at least one response level upon each incidence of said at least one receiver computer processor receiving current behavior data.

61) A behavior tracking system, relating to computerized storage and manipulation of behavior data, comprising:
a) at least one Internet server provider computer processor adapted to provide at least one Internet data server comprising
i) at least one nth subdirectory comprising
(1) at least one nth computer data storage program;
(2) at least one nth custom interface program; and
ii) at least one (n+1)th subdirectory comprising
(1) at least one (n+1)th computer data storage program;
(2) at least one (n+1)th custom interface program;
b) at least one nth authorizer computer processor adapted to only permit at least one authorized user of said at least one nth computer data storage program to alter data contained in said at least one nth student computer data storage program, using said at least one nth custom interface program; and
c) at least one (n+1)th authorizer computer processor adapted to only permit at least one authorized user of said at least one (n+1)th computer data storage program to alter data contained in said at least one (n+1)th student computer data storage program, using said at least one (n+1)th custom interface program.
